(19) United States
(12) Patent Application Publication
(10) Pub. No.: US 2024/0352208 A1
(43) Pub. Date: Oct. 24, 2024

(54) A Membrane and a Method of Making the Same

(71) Applicant: AGENCY FOR SCIENCE, TECHNOLOGY AND RESEARCH, Singapore (SG)

(72) Inventors: Simin Shermin Goh, Singapore (SG); Yuan Chong Jason Lim, Singapore (SG); Kim Kui Georgina Estelle Seah, Singapore (SG); Yan Xuan Angeline Tan, Singapore (SG); Chuan Hui Lionel Moh, Singapore (SG)

(21) Appl. No.: 18/687,421

(22) PCT Filed: Aug. 25, 2022
(86) PCT No.: PCT/SG2022/050606

§ 371 Date: Feb. 28, 2024

(30) Foreign Application Priority Data
Aug. 31, 2021 (SG) 10202109530R

(51) Int. Cl. C08J 5/22

(52) U.S. Cl. CPC C08J 5/2243; C08J 2367/07

(57) ABSTRACT

There is provided an ion selective membrane comprising a polymer matrix and an ionic lipophilic additive covalently bonded to the polymer matrix. There are also provided a method of preparing the ion selective membrane, an ion selective electrode comprising the ion selective membrane and a method of preparing the ion selective electrode.

### REFERENCES TO RELATED APPLICATION

This application claims priority to Singapore application Ser. No. 10202109530R filed with the Intellectual Property Office of Singapore on 31 Aug. 2021, the contents of which is hereby incorporated by reference.

### TECHNICAL FIELD

The present invention generally relates to an ion selective membrane and a method of preparing the ion selective membrane. The present invention further relates to an ion selective electrode and a method of preparing the ion selective electrode.

### BACKGROUND ART

Nitrates are important nutrients for plants and are commonly applied in fertilizer. However, overapplication of fertilizers can result in leaching of nitrates into water bodies. Humans and other animals, in contrast, can suffer from nitrate poisoning at high dosage levels. Hence, the control of nitrate levels in fertilizer, soil, water and food is crucial.

Nitrate levels in aqueous solutions can be detected with nitrate selective electrodes, which are conferred their selectivity by the nitrate selective membrane.

Nitrate selective membranes typically consist of three components: polymer matrix, plasticizer and ionic lipophilic additive (see FIG. 1). Ion-selective electrodes based on these membranes usually suffer from reduced performance (such as sensitivity and/or selectivity) over time due to leaching of ionic lipophilic additive and/or plasticizer from the polymer matrix.

Another conventional nitrate selective membrane comprises immobilized ionic lipophilic additive, which are covalently attached to a polymer matrix to prevent leaching (see FIG. 1). However, a plasticizer is still present in a suspended form in the polymer matrix, thus leaching of this component over time also results in reduced performance and lifespan.

Phosphates are important nutrients for plants and are commonly applied in fertilizer. However, overapplication of fertilizers can result in leaching of phosphates into water bodies. Humans and other animals, in contrast, can suffer from phosphate poisoning at high dosage levels. Hence, the control of phosphate levels in fertilizer, soil, water and food is crucial.

Phosphate levels in aqueous solutions can be detected with phosphate ion-selective electrodes, which are conferred their selectivity by the phosphate selective membrane. However, compared to other commonly encountered anions such as chloride, nitrate and bromide, the electrochemical sensing of phosphates is much more challenging. This is due to phosphates' multiple pH-dependent protonation equilibria occurring in solution (depending on pH, phosphates can exist as H₃PO₄, HPO₄²⁻, H₂PO₄ or PO₄³⁻), their highly hydrated nature and large size. Thus, to improve selectivity and reduce interference from these ions, phosphate ion-selective electrodes traditionally contain heavy metals (e.g. cobalt, uranium) or organotin compounds (e.g., bis(p-chlorobenzyl) tindichloride, dibenzyltin dichloride) to enhance their interactions with phosphate species.

Phosphate selective membranes typically consist of four components: polymer matrix, plasticizer, ionophore and cationic lipophilic salt. Ion-selective electrodes based on these membranes typically suffer from reduced performance (sensitivity, selectivity) over time due to leaching of ionophore, lipophilic salt and/or plasticizer from the polymer matrix. Importantly, hydrolysis and/or leaching of metal-based membrane components into the soil not only shortens the lifespan of the membrane, but also causes unwanted and health-hazardous heavy metal contamination.

Another conventional phosphate selective membrane comprises immobilized ionophores, which are covalently attached to a polymer matrix to prevent leaching (see FIG. 6). However, the cationic lipophilic salt and the plasticizer are still suspended in the polymer matrix; leaching of these components over time also results in reduced performance and lifespan.

Potassium is an important nutrient for plants and is commonly applied in fertilizer. However, overapplication of fertilizers can result in leaching of potassium into water bodies. Humans and other animals, in contrast, can suffer from potassium poisoning at high dosage levels. Hence, the control of potassium levels in fertilizer, soil, water and food is crucial.

Potassium levels in aqueous solutions can be detected with potassium ion-selective electrodes, which are conferred their selectivity by the potassium selective membrane. Potassium selective membranes typically consist of four components: polymer matrix, plasticizer, ionophore and anionic lipophilic salt. Ion-selective electrodes based on these membranes typically suffer from reduced performance (such as sensitivity and/or selectivity) over time due to leaching of ionophore, lipophilic salt and/or plasticizer from the polymer matrix.

To increase the lifespan of potassium selective membranes, another conventional potassium selective membrane comprises an immobilized potassium ionophore in a self-plasticising membrane to form a two-component membrane. Particularly, the ionophore is covalently attached to the polymer matrix which is self-plasticising, so leaching of ionophore and plasticier is minimised (see FIG. 9). However, the anionic lipophilic salt is still suspended in the polymer matrix; and leaching of this component over time also results in reduced performance and lifespan.

Accordingly, there is a need for an ion selective membrane that ameliorates one or more disadvantages mentioned above.

### SUMMARY

In one aspect, there is provided an ion selective membrane comprising a polymer matrix and an ionic lipophilic additive covalently bonded to the polymer matrix.

Advantageously, the ion selective membrane may have an improved lifespan as the components are not readily leached out when in use. Unexpectedly, the improved lifespan of the ion selective membrane may be more than 100 days of continuous usage.

Further advantageously, the ion selective membrane does not have lower or modified selectivity when all components are covalently bonded to the polymer matrix.

In another aspect, there is provided a method of preparing an ion selective membrane, comprising the steps of:
(a) mixing an ionic lipophilic additive monomer and a membrane base to form a mixture; and
(b) casting and curing the mixture of step (a) to form the membrane.

In another aspect, there is provided an ion selective electrode comprising the ion selective membrane as described herein and an electrode.

In another aspect, there is provided a method of preparing an ion selective electrode, comprising the steps of:
(a) providing a mixture of an ionic lipophilic additive monomer and a membrane base; and
(b) casting and curing the mixture of step (a) on an electrode to form the ion selective electrode.

### Definitions

The following words and terms used herein shall have the meaning indicated:

As used herein, the term “alkyl group” includes within its meaning monovalent (“alkyl”) and divalent (“alkylene”) straight chain or branched chain saturated aliphatic groups having from 1 to 10 carbon atoms, e.g., 1, 2, 3, 4, 5, 6, 7, 8, 9, or 10 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, and the like. For example, the term “alkylene” includes, but is not limited to methylene, ethylene, 1,2-propylene, 1,3-propylene octylene, nonylene, decylene, and the like.

The term “alkenyl group” includes within its meaning monovalent (“alkenyl”) and divalent (“alkenylene”) straight or branched chain unsaturated aliphatic hydrocarbon groups having from 2 to 10 carbon atoms, e.g., 2, 3, 4, 5, 6, 7, 8, 9, or 10 carbon atoms and having at least one double bond, of either E, Z, cis or trans stereochemistry where applicable, anywhere in the alkyl chain. Examples of alkenyl groups include but are not limited to ethenyl, vinyl, allyl, 1-methylvinyl, 1-propenyl, 2-propenyl, 2-methyl-1-propenyl, 2-methyl-1-propenyl, 1-butenyl, 2-butenyl, 3-butentyl, 1,3-butadienyl, 1-pentenyl, 2-pententyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 2-heptentyl, 3-heptenyl, 1-octenyl, 1-nonenyl, 1-decenyl, and the like.

The term “aromatic group”, or variants such as “aryl” or “arylene” as used herein refers to monovalent (“aryl”) and divalent (“arylene”) single, polynuclear, conjugated and fused residues of aromatic hydrocarbons having from 6 to 10 carbon atoms. Examples of such groups include phenyl, biphenyl, naphthyl, phenanthrenyl, and the like.

In the context of this description, the term “alkenyl” and “alkylarylalkenyl” may be construed to have at least one C═C double bond wherein the position of the double bond(s) is not particularly limited. Therefore, the “alkenyl” or “alkylarylalkenyl” may be connected to other groups via the double bond. The “alkenyl” or “alkylarylalkenyl” may also have the double bond at a terminus in the form of —CH═CH₂, thus the double bond is not connected to any other group.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

The term “about” as used herein typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of an ion selective membrane will now be disclosed.

The ion selective membrane may comprise a polymer matrix and an ionic lipophilic additive covalently bonded to the polymer matrix.

The ion selective membrane may selectively bind to a single ion. As an example, the ion selective membrane may selectively bind to nitrate ions, phosphate ions (including monohydrogen phosphate and dihydrogen phosphate) or potassium ions. Therefore, the ion selective membrane may be regarded as a nitrate selective membrane, a phosphate (including monohydrogen phosphate and dihydrogen phosphate) selective membrane or a potassium selective membrane.

As all components of the ion selective membrane are covalently bonded together, the ion selective membrane may be deemed as a single unit or integral unit. Advantageously, the ion selective membrane may have an improved lifespan as all components are covalently bonded together as compared to a conventional ion selective matrix where the ionic lipophilic additive is not covalently bonded to the polymer matrix or to a conventional ion selective matrix where the ionic lipophilic additive and a plasticizer are merely dispersed within a polymer matrix.

The polymer matrix may be self-plasticising. The polymer matrix may be a copolymer. The polymer matrix may comprise polymer repeating units, cross linkers and initiators.

The initiators may start a polymerisation reaction that polymerises the polymer repeating units and cross linkers. The initiators may be incorporated into the polymer matrix after the polymerisation reaction as end groups. Non-limiting examples of the initiators include 2,2-Dimethoxy-2-phenylacetophenone, Diphenyl(2,4,6-trimethylbenzoyl) phosphine oxide, Phenylbis(2,4,6-trimethylbenzoyl) phosphine oxide, azobisisobutyronitrile, 2,2′-Azobis(4-methoxy-2,4-dimethylvaleronitrile), 2,2′-Azobis(2,4-dimethylvaleronitrile).

The initiators may be photo initiators or thermal initiators.

The polymer repeating unit may be a C₁ to C₁₀ alkylene group having at least one substituent, wherein the alkylene group is derived from an alkenyl group in a monomer that polymerises into the polymer matrix. Non-limiting examples of the substituent include C₁ to C₁₀ alkyl carboxylate, C₃ to C₁₀ cycloalkyl carboxylate, C₁ to C₁₀ alkyl, or combinations thereof.

The substituent may be n-butyl carboxylate, n-hexyl carboxylate, methyl carboxylate, methyl, tetrahydrofurfuryl carboxylate or combinations thereof.

The cross linkers may comprise two substituted C₁ to C₁₀ alkylene groups covalently linked to each other, wherein the alkylene groups are derived from alkenyl groups in di-functionalised monomers that polymerise into the cross linkers. The two substituted alkylene groups are linked by a divalent substituent. The divalent substituent may be hexylene dicarboxylate. Therefore, each of the alkylene group may be deemed as having a substituted carboxylate as the substituent.

The alkylene groups of the cross linker may independently insert into two pairs of two adjacent polymer repeating units to cross link the polymer matrix via connections between the alkylene groups of the cross linker and the alkylene groups of the polymer repeating units.

The ionic lipophilic additive may help to balance the charge of the membrane against the ion it binds.

The ionic lipophilic additive may comprise an optionally substituted C₁ to C₂₀ alkylene group. The C₁ to C₂₀ alkylene group may comprise an optional substituent having at least one lipophilic group and at least one charged group that are covalently bonded together. The alkylene group may derived from an alkenyl group in a monomer that polymerises into the ionic lipophilic additive.

Non-limiting examples of the lipophilic group include C₁ to C₂₀ alkyl, C₁ to C₂₀ alkylene, amide, ester, ether, triazole, sulfonate ester, sulfonamide, phosphonate esters, phosphoramidates or combinations thereof.

A lipophilic group or a charged group may be linked to another lipophilic group or another charged group or the alkylene group via covalent bond.

The charged group may be cationic or anionic.

Non-limiting examples of the cationic charged group include ammonium, phosphonium, sulfonium, imidazolium, triazolium, guanidinium or combinations thereof.

Where the charged group is a cationic charged group, the ionic lipophilic additive may have a formula of R¹R²R³R⁴X,
wherein R¹, R² and R³ are independently selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof;
R⁴ is selected from a C₁ to C₂₀ alkylene, a C₂ to C₂₀ alkenylene or a C₉ to C₂₀ alkylarylalkenylene; and
X is N or P.

The ionic lipophilic additive may be covalently bonded to the polymer matrix through R⁴.

The cationic charged group may be

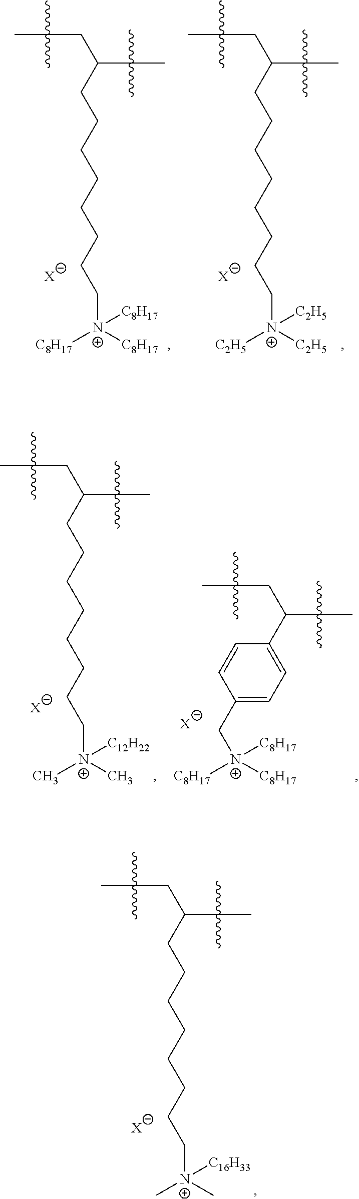

wherein X is an anion.

Non-limiting examples of X include fluoride, chloride, bromide, iodide or combinations thereof.

Non-limiting examples of the anionic charged group include sulfonate, carboxylate, phosphonate, borate, boronate, imide, imidate/amidate, sulfonimide or combinations thereof.

The anionic charged group may be

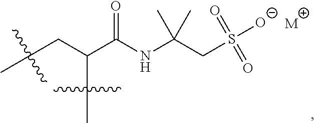

wherein M is a cation.

Non-limiting examples of M include lithium, sodium, potassium, ammonium or combinations thereof.

The ion selective membrane may consist of the polymer matrix and the ionic lipophilic additive.

The ion selective membrane may further comprise an ionophore covalently bonded to the polymer matrix. The ionophore may enhance the selectivity of the ion selective membrane towards specific ions of interest based on its chemical structure. As both the ionophore and the ionic lipophilic additive are covalently bonded to the polymer matrix, the ion selective membrane may be deemed as a single unit or integral unit.

The ionophore may be neutral or charged.

The ionophore may comprise a linker group and a binding group.

The linker group may comprise an optionally substituted C₁ to C₂₀ alkylene group, wherein the alkylene group is derived from an optionally substituted alkenyl group in the ionophore monomer. The linker group may link the ionophore and the polymer matrix via a covalent bond or a carbonyl, ester, amide, ether, triazole, sulfonate ester, sulfonamide, phosphonate ester, phosphoramidate, or combinations thereof.

The binding group may comprise a macrocyclic group having a ring structure comprising at least 12 atoms. The macrocyclic group may have a cavity to selectively bind the ions of interest via multidentate coordination.

The macrocyclic group may comprise a crown ether. As crown ethers are known to bind metal cations via oxygen and nitrogen coordination, with selectivity depending on crown ether size, the macrocyclic group and the ionophore comprising the macrocyclic group may be selective to the metal cations.

The macrocyclic group may alternatively or additionally comprise amide, thioamide, urea or thiourea groups that may form hydrogen bonds to oxy-anions.

The macrocyclic group may alternatively or additionally comprise halogen atoms that may form halogen bonds with oxy-anions or halogen anions.

The macrocyclic group may alternatively or additionally consist of n amide groups and n groups of formula A alternatingly linked together via covalent bonds, wherein A is selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof; and wherein n is independently an integer selected from 3 to 6.

The macrocyclic group may alternatively or additionally consist of m groups of formula Y and m groups of formula B alternatingly linked together via covalent bonds, wherein B is selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof; wherein m is independently an integer selected from 3 to 10; and wherein each occurrence of Y is independently selected from the group consisting of —O—, —S—, —NH—, and —PH—.

In the ionophore, the binding group may alternatively or additionally comprise a three-dimensional polycyclic group capable of selectively binding the ions of interest by multidentate interactions within its highly-preorganised cavity.

The polycyclic group may comprise cryptands or aza-cryptands. As these structures are known to bind metal cations via oxygen and nitrogen coordination, with selectivity depending on size of the cryptand cavity, the polycyclic group and the ionophore comprising the polycyclic group may be selective to the metal ions.

In the ionophore, the binding group may alternatively or additionally comprise an acyclic multipodal group having a formula of D(Z)ₒ,
wherein D is a branching point and Z is an arm, and wherein each arm is connected to the branching point via a covalent bond.

The branching point may be a single atom or a cyclic moiety.

Non-limiting examples of the single atom include —C—, —O—, —S—, —N—, —P—, —B— or combinations thereof.

The cyclic moiety may be an optionally substituted aromatic group.

The arm may comprise a linker moiety and a binding moiety, wherein the linker moiety has one end connected to the branching point and another end connected to the binding moiety.

The linker moiety may be selected from the group consisting of C₁ to C₂₀ alkylene, C₁ to C₂₀ heteroalkylene, C₃ to C₂₀ cycloalkylene, C₃ to C₂₀ heterocycloalkylene, C₂ to C₂₀ alkenylene, C₂ to C₂₀ heteroalkenylene, C₃ to C₂₀ cycloalkenylene, C₃ to C₂₀ heterocycloalkenylene, C₂ to C₂₀ alkynylene, C₂ to C₂₀ heteroalkynylene, C₃ to C₂₀ cycloalkynylene, C₃ to C₂₀ heterocycloalkynylene, C₇ to C₂₀ aralkylene, C₇ to C₂₀ heteroaralkylene and combinations thereof.

The binding moiety may comprise an amide moiety, a thioamide moiety, a urea moiety or a thiourea moiety. These moieties may form hydrogen bonds with oxy-anions. Where the binding moiety comprises an amide moiety or a thioamide moiety, the binding moiety may coordinate with metal cations.

The binding moiety may alternatively or additionally comprise a halogen moiety. This moiety may form halogen bonds with oxy-anions or halide anions.

The number o may be an integer in the range of 2 to 6. Where o is 2, the multipodal group may also be considered a tweezer-type group.

The multipodal group may form a binding pocket to selectively bind the ions of interest through preorganisation.

In the ionophore, the binding group may alternatively or additionally comprise a metal complex group. The metal complex group may comprise a metal cation that is coordinated by suitable organic ligands. The metal ion may be an ion of a main group element, a transition metal or a lanthanide. As the metal complex group is known to bind oxy-anions and halogen anions, with selectivity dictated by the identity of the metal and structure of the organic ligands, the metal complex group and the ionophore comprising the metal complex group may be selective to the oxy-anions or halogen anions.

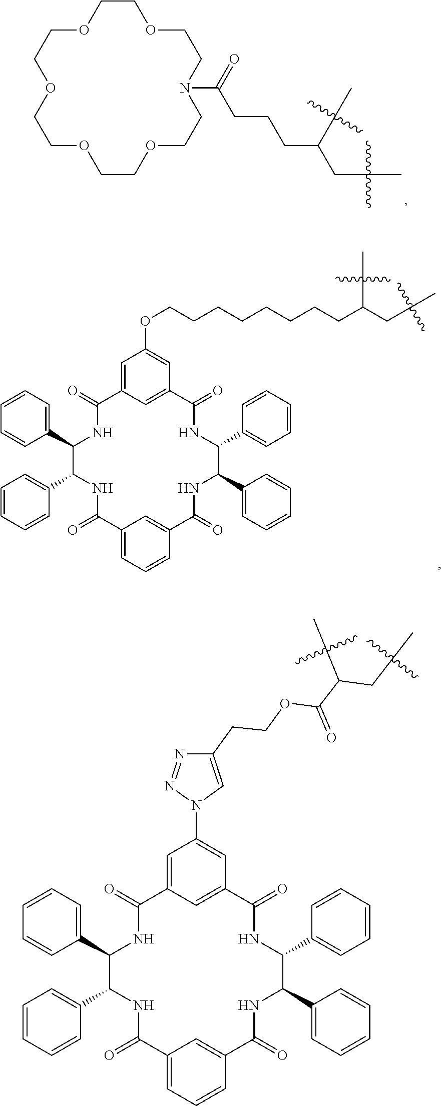 [SMILES: *CC(*)CCCC(=O)N1CCOCCOCCOCCOCCOCC1 ; *CC(*)CCCCCCCCOc1cc2cc(c1)C(=O)N[C@H](c1ccccc1)[C@@H](c1ccccc1)NC(=O)c1cccc(c1)C(=O)N[C@H](c1ccccc1)[C@@H](c1ccccc1)NC2=O ; *CC(*)C(=O)OCCc1cn(-c2cc3cc(c2)C(=O)N[C@H](c2ccccc2)[C@@H](c2ccccc2)NC(=O)c2cccc(c2)C(=O)N[C@H](c2ccccc2)[C@@H](c2ccccc2)NC3=O)nn1]

The ionophore may have a formula selected from or combinations thereof.

Where the ionophore does not comprise metal, the use of the non-metal ionophore may avoid metal complex hydrolysis and leaching when the ion selective membrane is used continuously or for long periods of time.

The alkenyl group of the ionophore monomer may insert into two adjacent polymer repeating units to be covalently bonded to the polymer matrix via connections between the alkenyl group of the ionophore monomer and the alkenyl groups of the polymer repeating units.

The ion selective membrane may consist of the polymer matrix and the ionophore covalently bonded to the polymer matrix.

Exemplary, non-limiting embodiments of a method of preparing an ion selective membrane will now be disclosed.

The method may comprise the steps of:
(a) mixing an ionic lipophilic additive monomer and a membrane base to form a mixture; and
(b) casting and curing the mixture of step (a) to form the membrane.

The ionic lipophilic additive monomer may be an optionally substituted alkenyl group, wherein the substituent may comprise at least one lipophilic group and at least one charged group that are covalently bonded together. The ionic lipophilic additive monomer may be polymerised in step (b) to form an ionic lipophilic additive.

Non-limiting examples of the lipophilic group include C₁ to C₂₀ alkyl, C₁ to C₂₀ alkylene, amide, ester, ether, triazole, sulfonate ester, sulfonamide, phosphonate esters, phosphoramidates or combinations thereof.

A lipophilic group or a charged group may be linked to another lipophilic group or another charged group or the alkenyl group via covalent bond.

The charged group may be cationic or anionic.

Non-limiting examples of the cationic charged group include ammonium, phosphonium, sulfonium, imidazolium, triazolium, guanidinium or combinations thereof.

Where the charged group is a cationic charged group, the ionic lipophilic additive monomer may have a formula of R¹R²R³R⁴X,
wherein R¹, R² and R³ are independently selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof;
R⁴ is selected from a C₂ to C₂₀ alkenyl, a C₉ to C₂₀ alkylarylalkenyl, or a C₃ to C₂₀ alkenyl carboxylate; and
X is N or P.

The ionic lipophilic additive monomer may be polymerised in step (b) to form an ionic lipophilic additive. The ionic lipophilic additive may enhance the selectivity of the ion selective membrane towards specific ions based on its chemical structure. The membrane base may be polymerised in step (b) to form a polymer matrix. The ionic lipophilic additive may be covalently bonded to the polymer matrix through R⁴.

The cationic charged group may be

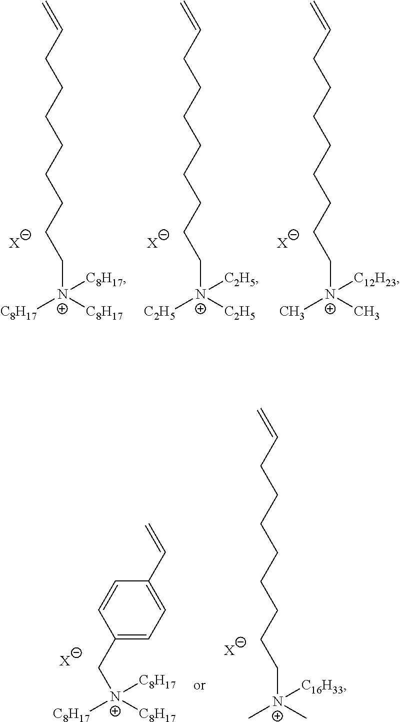

wherein X is an anion.

Non-limiting examples of X include fluoride, chloride, bromide, iodide or combinations thereof.

Non-limiting examples of the anionic charged group include sulfonate, carboxylate, phosphonate, borate, boronate, imide, imidate/amidate, sulfonimide or combinations thereof.

The anionic charged group may be

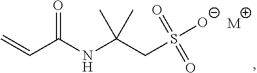

wherein M is a cation.

Non-limiting examples of M include lithium, sodium, potassium, ammonium or combinations thereof.

The method may further comprise a step of adding an ionophore monomer into the mixture of step (a) after step (a) but before step (b).

The ionophore monomer may be neutral or charged.

The ionophore monomer may comprise a linker group and a binding group.

The linker group may be an optionally substituted C₁ to C₂₀ alkenyl group. The linker group may link the ionophore monomer and the membrane via a covalent bond or via a carbonyl, ester, amide, ether, triazole, sulfonate ester, sulfonamide, phosphonate ester, phosphoramidate, or combinations thereof.

The binding group may be a macrocyclic group having a ring structure comprising at least 12 atoms. The macrocyclic group may have a cavity to selectively bind the ions of interest via multidentate coordination.

The macrocyclic group may comprise a crown ether. As crown ethers are known to bind metal cations via oxygen and nitrogen coordination, with selectivity depending on crown ether size, the macrocyclic group and the ionophore monomer comprising the macrocyclic group may be selective to the metal cations.

The macrocyclic group may alternatively or additionally comprise amide, thioamide, urea or thiourea groups that may form hydrogen bonds to oxy-anions.

The macrocyclic group may alternatively or additionally comprise halogen atoms that may form halogen bonds with oxy-anions or halogen anions.

The macrocyclic group may alternatively or additionally consist of n amide groups and n groups of formula A alternatingly linked together via covalent bonds, wherein A is selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof; and wherein n is independently an integer selected from 3 to 6.

The macrocyclic group may alternatively or additionally consist of m groups of formula Y and m groups of formula B alternatingly linked together via covalent bonds, wherein B is selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof; wherein m is independently an integer selected from 3 to 10; and wherein each occurrence of Y is independently selected from the group consisting of —O—, —S—, —NH—, and —PH—.

In the ionophore monomer, the binding group may alternatively or additionally be a three-dimensional polycyclic group capable of selectively binding the ions of interest by multidentate interactions within its highly-preorganised cavity.

The polycyclic group may comprise cryptands or aza-cryptands. As these structures are known to bind metal cations via oxygen and nitrogen coordination, with selectivity depending on size of the cryptand cavity, the polycyclic group and the ionophore monomer comprising the polycyclic group may be selective to the metal ions.

In the ionophore monomer, the binding group may alternatively or additionally be an acyclic multipodal group having a formula of D(Z)ₒ,
wherein D is a branching point and Z is an arm, and wherein each arm is connected to the branching point via a covalent bond.

The branching point may be a single atom or a cyclic moiety.

Non-limiting examples of the single atom include —C—, —O—, —S—, —N—, —P—, —B— or combinations thereof.

The cyclic moiety may be an optionally substituted aromatic group.

The arm may comprise a linker moiety and a binding moiety, wherein the linker moiety has one end connected to the branching point and another end connected to the binding moiety.

The linker moiety may be selected from the group consisting of C₁ to C₂₀ alkylene, C₁ to C₂₀ heteroalkylene, C₃ to C₂₀ cycloalkylene, C₃ to C₂₀ heterocycloalkylene, C₂ to C₂₀ alkenylene, C₂ to C₂₀ heteroalkenylene, C₃ to C₂₀ cycloalkenylene, C₃ to C₂₀ heterocycloalkenylene, C₂ to C₂₀ alkynylene, C₂ to C₂₀ heteroalkynylene, C₃ to C₂₀ cycloalkynylene, C₃ to C₂₀ heterocycloalkynylene, C₇ to C₂₀ aralkylene, C₇ to C₂₀ heteroaralkylene and combinations thereof.

The binding moiety may comprise an amide moiety, a thioamide moiety, a urea moiety or a thiourea moiety. These moieties may form hydrogen bonds with oxy-anions. Where the binding moiety comprises an amide moiety or a thioamide moiety, the binding moiety may coordinate with metal cations.

The binding moiety may alternatively or additionally comprise a halogen moiety. This moiety may form halogen bonds with oxy-anions or halide anions.

The number o may be an integer in the range of 2 to 6. Where o is 2, the multipodal group may also be considered a tweezer-type group.

The multipodal group may form a binding pocket to selectively bind the ions of interest through preorganisation.

In the ionophore monomer, the binding group may alternatively or additionally be a metal complex group. The metal complex group may comprise a metal cation that is coordinated by suitable organic ligands. The metal ion may be an ion of a main group element, a transition metal or a lanthanide. As the metal complex group is known to bind oxy-anions and halogen anions, with selectivity dictated by the identity of the metal and structure of the organic ligands, the metal complex group and the ionophore monomer comprising the metal complex group may be selective to the oxy-anions or halogen anions.

The ionophore monomer may be selected from the compounds of formula

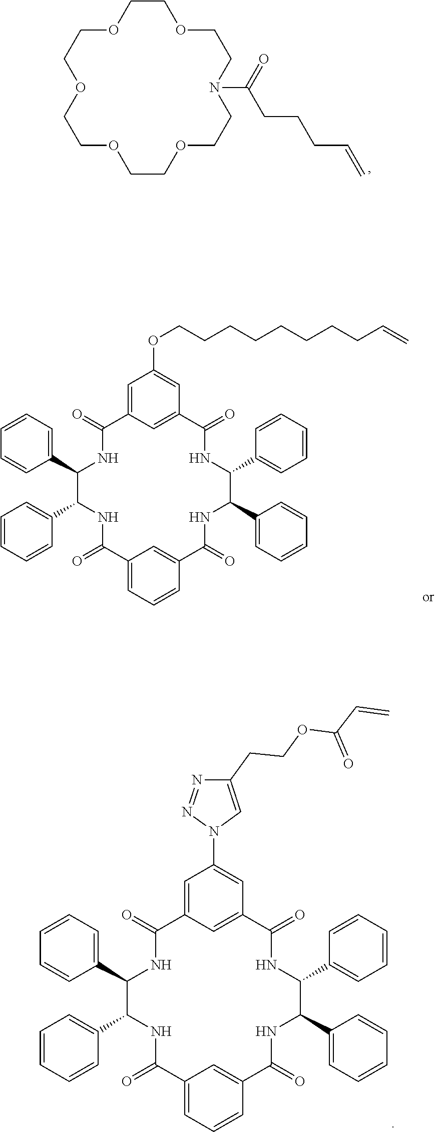 [SMILES: C=CCCCC(=O)N1CCOCCOCCOCCOCCOCC1 ; C=CCCCCCCCCOc1cc2cc(c1)C(=O)N[C@H](c1ccccc1)[C@@H](c1ccccc1)NC(=O)c1cccc(c1)C(=O)N[C@H](c1ccccc1)[C@@H](c1ccccc1)NC2=O ; C=CC(=O)OCCc1cn(-c2cc3cc(c2)C(=O)N[C@H](c2ccccc2)[C@@H](c2ccccc2)NC(=O)c2cccc(c2)C(=O)N[C@H](c2ccccc2)[C@@H](c2ccccc2)NC3=O)nn1]

In the mixing step (a), the membrane base may comprise monomers, cross linkers and initiators.

The monomers may be a C₁ to C₁₀ alkenyl group having at least one substituent. Non-limiting examples of the substituent include carboxylate, C₁ to C₁₀ alkyl or combinations thereof.

The substituent may be n-butyl carboxylate, n-hexyl carboxylate, methyl carboxylate, methyl, tetrahydrofurfuryl carboxylate or combinations thereof.

The cross linkers may comprise two substituted C₁ to C₁₀ alkylene groups covalently linked to each other. The two substituted alkylene groups are linked by a divalent substituent. The divalent substituent may be hexylene dicarboxylate. Therefore, each of the alkylene group may be deemed as having a substituted carboxylate as the substituent.

The initiators may be photo initiators or thermal initiators.

Non-limiting examples of the initiators include 2,2-Dimethoxy-2-phenylacetophenone, Diphenyl(2,4,6-trimethylbenzoyl) phosphine oxide, Phenylbis(2,4,6-trimethylbenzoyl) phosphine oxide, azobisisobutyronitrile, 2,2′-Azobis(4-methoxy-2,4-dimethylvaleronitrile), 2,2′-Azobis(2,4-dimethylvaleronitrile).

In the adding step, the ionic lipophilic additive monomer may be added at a weight percentage in the range of about 0.5 weight % to about 20 weight %, about 10 weight % to about 20 weight %, about 0.5 weight % to about 10 weight %, about 1 weight % to about 10 weight % or about 1 weight % to about 5 weight % based on the total weight of the mixture.

In the adding step, the ionophore monomer (when present) may be added at a weight percentage in the range of about 0.5 weight % to about 15 weight %, about 10 weight % to about 15 weight %, about 0.5 weight % to about 10 weight %, about 1 weight % to about 10 weight % or about 1 weight % to about 5 weight % based on the total weight of the mixture.

In the mixing step (a), the membrane base may be added at a weight percentage in the range of about 80 weight % to about 99.5 weight %, about 90 weight % to about 99.5 weight %, about 95 weight % to about 99.5 weight %, about 80 weight % to about 95 weight % or about 85 weight % to about 90 weight % based on the total weight of the mixture.

In the mixing step (a), the monomers may be added at a weight percentage in the range of about 97 weight % to about 98.95 weight %, about 98 weight % to about 98.95 weight % or about 97 weight % to about 98 weight % based on the total weight of the membrane base.

In the mixing step (a), the cross linkers may be added at a weight percentage in the range of about 0.05 weight % to about 1.5 weight %, about 0.1 weight % to about 1.5 weight %, about 0.5 weight % to about 1.5 weight %, about 1 weight % to about 1.5 weight %, about 0.05 weight % to about 1 weight %, about 0.05 weight % to about 0.5 weight % or about 0.05 weight % to about 0.1 weight % based on the total weight of the membrane base.

In the mixing step (a), the initiator may be added at a weight percentage in the range of about 1 weight % to about 1.5 weight %, about 1.1 weight % to about 1.5 weight %, about 1.2 weight % to about 1.5 weight %, about 1 weight % to about 1.2 weight % or about 1 weight % to about 1.1 weight % based on the total weight of the membrane base.

In the adding step, the mixing of the ionophore monomer (when present), ionic lipophilic additive monomer and the membrane base may be undertaken by stirring at room temperature for a duration in the range of about 5 minutes to about 1 hour, about 20 minutes to about 1 hour, about 40 minutes to about 1 hour, about 5 minutes to about 40 minutes or about 5 minutes to about 20 minutes.

The method may further comprise a step of adding a co-solvent into the mixture of step (a) after step (a) but before step (b).

The co-solvent may expedite the dissolving of the ionophore monomer (when present), ionic lipophilic additive monomer and the membrane base. Non-limiting examples of the co-solvent include ethyl acetate, tetrahydrofuran, dioxane, N, N-dimethylformamide, N, N-dimethylacetamide or combinations thereof.

The co-solvent may be added at a quantity in the range of about 5 g/mL to about 50 g/mL, about 10 g/mL to about 50 g/mL, about 25 g/mL to about 50 g/mL, about 5 g/mL to about 25 g/mL or about 5 g/mL to about 10 g/mL. based on the total volume of the mixture of step (a).

In the casting and curing step (b), the mixture of step (a) may be cast on a substrate and subsequently cured by irradiation from a light source.

The casting step may be undertaken with about 0.3 μL/mm to about 2 μL/mm, about 0.5 L/mm to about 2 μL/mm, about 1 μL/mm to about 2 μL/mm, about 0.3 L/mm to about 1 μL/mm or about 0.3 L/mm to about 0.5 L/mm of the mixture of step (a) per millimeter of diameter of the substrate.

The substrate may be an electrode. When the substrate is the electrode, the ion selective membrane and the electrode may together be deemed as an ion selective electrode.

In the curing step, the light source may emit light at a wavelength in the range of about 300 nm to about 450 nm, about 350 nm to about 450 nm, about 400 nm to about 450 nm, about 300 nm to about 400 nm, about 300 nm to about 350 nm or about 400 nm to about 410 nm.

The light source may emit light at a power in the range of about 20 mW/cm² to about 250 mW/cm², about 100 mW/cm² to about 250 mW/cm², about 200 mW/cm² to about 250 mW/cm², about 20 mW/cm² to about 200 mW/cm² or about 20 mW/cm² to about 100 mW/cm².

Where a metal halide lamp is used as the light source, the metal halide light may emit light at a power in the range of about 100 mW/cm² to about 250 mW/cm², about 150 mW/cm² to about 250 mW/cm², about 200 mW/cm² to about 250 mW/cm², about 100 mW/cm² to about 200 mW/cm² or about 100 mW/cm² to about 150 mW/cm².

The curing step may be undertaken for a duration in the range of about 1 minute to about 20 minutes, about 10 minutes to about 20 minutes, about 15 minutes to about 20 minutes, about 1 minute to about 15 minutes or about 1 minute to about 10 minutes.

The curing step may be undertaken in an inert atmosphere, which may contain nitrogen or argon gas or any combinations of them.

Exemplary, non-limiting embodiments of an ion selective electrode will now be disclosed.

The ion selective electrode may comprise the ion selective membrane as described herein and an electrode. As an example, the ion selective electrode may be a nitrate selective electrode, a phosphate (including monohydrogen phosphate and dihydrogen phosphate) selective electrode or a potassium selective electrode.

The ion selective electrode may be an all-solid-state ion selective electrode.

The electrode may be made of a conductive material. Non-limiting examples of the conductive materials include carbon, copper, silver, gold, platinum, aluminium, graphite or combinations thereof.

The electrode may be a carbon electrode. The electrode may be a screen-printed carbon electrode. The electrode may be a polyaniline-coated screen-printed carbon electrode. The electrode may be a screen-printed carbon electrode coated with a conductive polymer selected from the group comprising poly(3,4-ethylenedioxythiophene) (PEDOT), polythiophene e.g. poly(3-octylthiophene) (POT), polyaniline (PANI), polypyrrole (PPy), polyazulene and combinations thereof. The electrode may be a screen-printed carbon electrode functionalised with carbon nanotubes or carbon nanofibers.

The electrode may be coated by the ion selective membrane. The ion selective membrane may fully cover the surface of the electrode.

Exemplary, non-limiting embodiments of a method of preparing an ion selective electrode will now be disclosed.

The method may comprise the steps of:
(a) providing a mixture of an ionic lipophilic additive monomer and a membrane base; and
(b) casting and curing the mixture of step (a) on an electrode to form the ion selective electrode.

The ionic lipophilic additive monomer may be an optionally substituted alkenyl group, wherein the substituent may comprise at least one lipophilic group and at least one charged group that are covalently bonded together. The ionic lipophilic additive monomer may be polymerised in step (b) to form an ionic lipophilic additive.

Non-limiting examples of the lipophilic group include C₁ to C₂₀ alkyl, C₁ to C₂₀ alkylene, amide, ester, ether, triazole, sulfonate ester, sulfonamide, phosphonate esters, phosphoramidates or combinations thereof.

A lipophilic group or a charged group may be linked to another lipophilic group or another charged group or the alkenyl group via covalent bond.

The charged group may be cationic or anionic.

Non-limiting examples of the cationic charged group include ammonium, phosphonium, sulfonium, imidazolium, triazolium, guanidinium or combinations thereof.

Where the charged group is a cationic charged group, the ionic lipophilic additive monomer may have a formula of R¹R²R³R⁴X,
wherein R¹, R² and R³ are independently selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof;
R⁴ is selected from a C₂ to C₂₀ alkenyl, a C₉ to C₂₀ alkylarylalkenyl, or a C₃ to C₂₀ alkenyl carboxylate; and
X is N or P.

The ionic lipophilic additive monomer may be polymerised in step (b) to form an ionic lipophilic additive. The ionic lipophilic additive may enhance the selectivity of the ion selective membrane towards specific ions based on its chemical structure. The membrane base may be polymerised in step (b) to form a polymer matrix. The ionic lipophilic additive may be covalently bonded to the polymer matrix through R⁴.

The cationic charged group may be

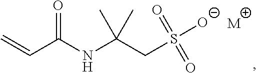

wherein X is an anion.

Non-limiting examples of X include fluoride, chloride, bromide, iodide or combinations thereof.

Non-limiting examples of the anionic charged group include sulfonate, carboxylate, phosphonate, borate, boronate, imide, imidate/amidate, sulfonimide or combinations thereof.

The anionic charged group may be

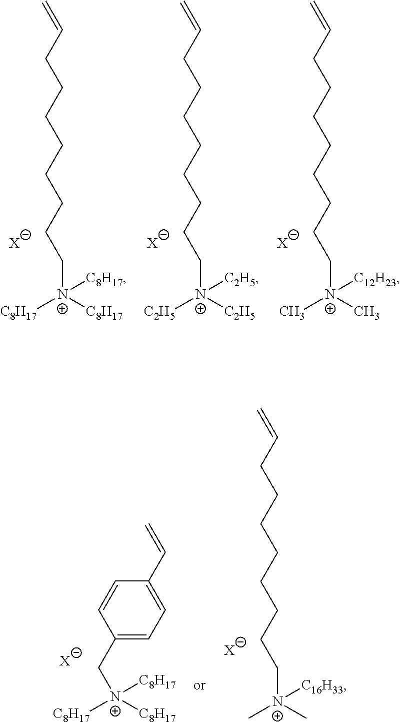

wherein M is a cation.

Non-limiting examples of M include lithium, sodium, potassium, ammonium or combinations thereof.

The method may further comprise a step of adding an ionophore monomer into the mixture of step (a) after step (a) but before step (b).

The ionophore monomer may be neutral or charged.

The ionophore monomer may comprise a linker group and a binding group.

The linker group may comprise an optionally substituted C₁ to C₂₀ alkenyl group. The linker group may link the ionophore monomer and the membrane via a covalent bond or a carbonyl, ester, amide, ether, triazole, sulfonate ester, sulfonamide, phosphonate ester, phosphoramidate, or combinations thereof.

The binding group may comprise a macrocyclic group having a ring structure comprising at least 12 atoms. The macrocyclic group may have a cavity to selectively bind the ions of interest via multidentate coordination.

The macrocyclic group may comprise a crown ether. As crown ethers are known to bind metal cations via oxygen and nitrogen coordination, with selectivity depending on crown ether size, the macrocyclic group and the ionophore monomer comprising the macrocyclic group may be selective to the metal cations.

The macrocyclic group may alternatively or additionally comprise amide, thioamide, urea or thiourea groups that may form hydrogen bonds to oxy-anions.

The macrocyclic group may alternatively or additionally comprise halogen atoms that may form halogen bonds with oxy-anions or halogen anions.

The macrocyclic group may alternatively or additionally consist of n amide groups and n groups of formula A alternatingly linked together via covalent bonds, wherein A is selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof; and wherein n is independently an integer selected from 3 to 6.

The macrocyclic group may alternatively or additionally consist of m groups of formula Y and m groups of formula B alternatingly linked together via covalent bonds, wherein B is selected from the group consisting of C₁ to C₂₀ alkyl, C₁ to C₂₀ heteroalkyl, C₃ to C₂₀ cycloalkyl, C₃ to C₂₀ heterocycloalkyl, C₂ to C₂₀ alkenyl, C₂ to C₂₀ heteroalkenyl, C₃ to C₂₀ cycloalkenyl, C₃ to C₂₀ heterocycloalkenyl, C₂ to C₂₀ alkynyl, C₂ to C₂₀ heteroalkynyl, C₃ to C₂₀ cycloalkynyl, C₃ to C₂₀ heterocycloalkynyl, C₇ to C₂₀ aralkyl, C₇ to C₂₀ heteroaralkyl and combinations thereof; wherein m is independently an integer selected from 3 to 10; and wherein each occurrence of Y is independently selected from the group consisting of —O—, —S—, —NH—, and —PH—.

In the ionophore monomer, the binding group may alternatively or additionally comprise a three-dimensional polycyclic group capable of selectively binding the ions of interest by multidentate interactions within its highly-preorganised cavity.

The polycyclic group may comprise cryptands or aza-cryptands. As these structures are known to bind metal cations via oxygen and nitrogen coordination, with selectivity depending on size of the cryptand cavity, the polycyclic group and the ionophore monomer comprising the polycyclic group may be selective to the metal ions.

In the ionophore monomer, the binding group may alternatively or additionally comprise an acyclic multipodal group having a formula of D(Z)ₒ,
wherein D is a branching point and Z is an arm, and wherein each arm is connected to the branching point via a covalent bond.

The branching point may be a single atom or a cyclic moiety.

Non-limiting examples of the single atom include —C—, —O—, —S—, —N—, —P—, —B— or combinations thereof.

The cyclic moiety may be an optionally substituted aromatic group.

The arm may comprise a linker moiety and a binding moiety, wherein the linker moiety has one end connected to the branching point and another end connected to the binding moiety.

The linker moiety may be selected from the group consisting of C₁ to C₂₀ alkylene, C₁ to C₂₀ heteroalkylene, C₃ to C₂₀ cycloalkylene, C₃ to C₂₀ heterocycloalkylene, C₂ to C₂₀ alkenylene, C₂ to C₂₀ heteroalkenylene, C₃ to C₂₀ cycloalkenylene, C₃ to C₂₀ heterocycloalkenylene, C₂ to C₂₀ alkynylene, C₂ to C₂₀ heteroalkynylene, C₃ to C₂₀ cycloalkynylene, C₃ to C₂₀ heterocycloalkynylene, C₇ to C₂₀ aralkylene, C₇ to C₂₀ heteroaralkylene and combinations thereof.

The binding moiety may comprise an amide moiety, a thioamide moiety, a urea moiety or a thiourea moiety. These moieties may form hydrogen bonds with oxy-anions.

Where the binding moiety comprises an amide moiety or a thioamide moiety, the binding moiety may coordinate with metal cations.

The binding moiety may alternatively or additionally comprise a halogen moiety. This moiety may form halogen bonds with oxy-anions or halide anions.

The number o may be an integer in the range of 2 to 6. Where o is 2, the multipodal group may also be considered a tweezer-type group.

The multipodal group may form a binding pocket to selectively bind the ions of interest through preorganisation.

In the ionophore monomer, the binding group may alternatively or additionally comprise a metal complex group. The metal complex group may comprise a metal cation that is coordinated by suitable organic ligands. The metal ion may be an ion of a main group element, a transition metal or a lanthanide. As the metal complex group is known to bind oxy-anions and halogen anions, with selectivity dictated by the identity of the metal and structure of the organic ligands, the metal complex group and the ionophore monomer comprising the metal complex group may be selective to the oxy-anions or halogen anions.

The ionophore monomer may be selected from the compounds of formula

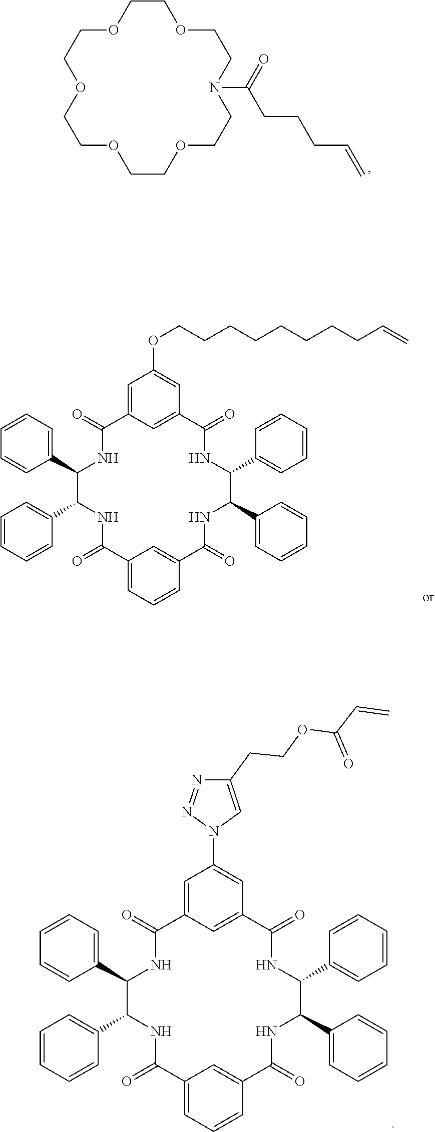 [SMILES: C=CCCCC(=O)N1CCOCCOCCOCCOCCOCC1 ; C=CCCCCCCCCOc1cc2cc(c1)C(=O)N[C@H](c1ccccc1)[C@@H](c1ccccc1)NC(=O)c1cccc(c1)C(=O)N[C@H](c1ccccc1)[C@@H](c1ccccc1)NC2=O ; C=CC(=O)OCCc1cn(-c2cc3cc(c2)C(=O)N[C@H](c2ccccc2)[C@@H](c2ccccc2)NC(=O)c2cccc(c2)C(=O)N[C@H](c2ccccc2)[C@@H](c2ccccc2)NC3=O)nn1]

In the providing step (a), the membrane base may comprise monomers, cross linkers and initiators.

The monomers may be a C₁ to C₁₀ alkenyl group having at least one substituent. Non-limiting examples of the substituent include carboxylate, C₁ to C₁₀ alkyl or combinations thereof.

The substituent may be n-butyl carboxylate, n-hexyl carboxylate, methyl carboxylate, methyl, tetrahydrofurfuryl carboxylate or combinations thereof.

The cross linkers may comprise two substituted C₁ to C₁₀ alkylene groups covalently linked to each other. The two substituted alkylene groups may share a divalent substituent that links them together. The divalent substituent may be hexylene dicarboxylate. Therefore, each of the alkylene group may be deemed as having a substituted carboxylate as the substituent.

The initiators may be photo initiators or thermal initiators.

Non-limiting examples of the initiators include 2,2-Dimethoxy-2-phenylacetophenone, Diphenyl(2,4,6-trimethylbenzoyl) phosphine oxide, Phenylbis(2,4,6-trimethylbenzoyl) phosphine oxide, azobisisobutyronitrile, 2,2′-Azobis(4-methoxy-2,4-dimethylvaleronitrile), 2,2′-Azobis(2,4-dimethylvaleronitrile).

In the adding step, the ionic lipophilic additive monomer may be added at a weight percentage in the range of about 0.5 weight % to about 20 weight %, about 10 weight % to about 20 weight %, about 0.5 weight % to about 10 weight %, about 1 weight % to about 10 weight % or about 1 weight % to about 5 weight % based on the total weight of the mixture.

In the adding step, the ionophore monomer (when present) may be added at a weight percentage in the range of about 0.5 weight % to about 15 weight %, about 10 weight % to about 15 weight %, about 0.5 weight % to about 10 weight %, about 1 weight % to about 10 weight % or about 1 weight % to about 5 weight % based on the total weight of the mixture.

In the providing step (a), the membrane base may be present in the mixture at a weight percentage in the range of about 80 weight % to about 99.5 weight %, about 90 weight % to about 99.5 weight %, about 95 weight % to about 99.5 weight %, about 80 weight % to about 95 weight % or about 85 weight % to about 90 weight % based on the total weight of the mixture.

In the providing step (a), the monomers may be present in the mixture at a weight percentage in the range of about 97 weight % to about 98.95 weight %, about 98 weight % to about 98.95 weight % or about 97 weight % to about 98 weight % based on the total weight of the membrane base.

In the providing step (a), the cross linkers may be present in the mixture at a weight percentage in the range of about 0.05 weight % to about 1.5 weight %, about 0.1 weight % to about 1.5 weight %, about 0.5 weight % to about 1.5 weight %, about 1 weight % to about 1.5 weight %, about 0.05 weight % to about 1 weight %, about 0.05 weight % to about 0.5 weight % or about 0.05 weight % to about 0.1 weight % based on the total weight of the membrane base.

In the providing step (a), the initiator may be present in the mixture at a weight percentage in the range of about 1 weight % to about 1.5 weight %, about 1.1 weight % to about 1.5 weight %, about 1.2 weight % to about 1.5 weight %, about 1 weight % to about 1.2 weight % or about 1 weight % to about 1.1 weight % based on the total weight of the membrane base.

In the adding step, the ionophore monomer (when present), ionic lipophilic additive monomer and the membrane base may be mixed by stirring at room temperature for a duration in the range of about 5 minutes to about 1 hour, about 20 minutes to about 1 hour, about 40 minutes to about 1 hour, about 5 minutes to about 40 minutes or about 5 minutes to about 20 minutes.

The method may further comprise a step of synthesizing the ionophore monomer (when present) and/or ionic lipophilic additive monomer before step (a).

The synthesizing step may be undertaken by functionalising a terminal alkene with an ion-binding group, thereby forming the ionophore.

The method may further comprise a step of adding a co-solvent into the mixture of step (a) after step (a) but before step (b).

The co-solvent may expedite the dissolving of the ionophore monomer (when present), ionic lipophilic additive monomer and the membrane base. Non-limiting examples of the co-solvent include ethyl acetate, tetrahydrofuran, dioxane, N,N-dimethylformamide, N, N-dimethylacetamide or combinations thereof.

The co-solvent may be added at a quantity in the range of about 5 g/mL to about 50 g/mL, about 10 g/mL to about 50 g/mL, about 25 g/mL to about 50 g/mL, about 5 g/mL to about 25 g/mL or about 5 g/mL to about 10 g/mL based on the total volume of the mixture of step (a).

In the casting and curing step (b), the mixture of step (a) may be cast on a substrate and subsequently cured by irradiation from a light source.

The casting step may be undertaken with about 0.3 μL/mm to about 2 μL/mm, about 0.5 μL/mm to about 2 μL/mm, about 1 μL/mm to about 2 μL/mm, about 0.3 μL/mm to about 1 μL/mm or about 0.3 L/mm to about 0.5 μL/mm of the mixture of step (a) per millimeter of diameter of the substrate.

The substrate may be an electrode. When the substrate is the electrode, the ion selective membrane and the electrode may together be deemed as an ion selective electrode.

The light source may emit light at a wavelength in the range of about 300 nm to about 450 nm, about 350 nm to about 450 nm, about 400 nm to about 450 nm, about 300 nm to about 400 nm, about 300 nm to about 350 nm or about 400 nm to about 410 nm.

The light source may emit light at a power in the range of about 20 mW/cm² to about 250 mW/cm², about 100 mW/cm² to about 250 mW/cm², about 200 mW/cm² to about 250 mW/cm², about 20 mW/cm² to about 200 mW/cm² or about 20 mW/cm² to about 100 mW/cm².

Where a metal halide lamp is used as the light source, the metal halide light may emit light at a power in the range of about 100 mW/cm² to about 250 mW/cm², about 150 mW/cm² to about 250 mW/cm², about 200 mW/cm² to about 250 mW/cm², about 100 mW/cm² to about 200 mW/cm² or about 100 mW/cm² to about 150 mW/cm².

The curing step may be undertaken for a duration in the range of about 1 minute to about 20 minutes, about 10 minutes to about 20 minutes, about 15 minutes to about 20 minutes, about 1 minute to about 15 minutes or about 1 minute to about 10 minutes.

The curing step may be undertaken in an inert atmosphere, which may contain nitrogen or argon gas or any combinations of them.

The method may further comprise a step of conditioning the ion selective electrode after step (b).

The conditioning step may be undertaken by soaking the ion selective electrode of step (b) in an aqueous solution of a salt of the ion that the ion selective electrode is selective towards for about 2 hours to about 48 hours, about 12 hours to about 48 hours, about 24 hours to about 48 hours, about 36 hours to about 48 hours, about 2 hours to about 36 hours, about 2 hours to about 24 hours or about 2 hours to about 12 hours.

The salt may have a concentration in the aqueous solution in the range of about 0.1 mM to about 100 mM, about 10 mM to about 100 mM, about 1 mM to about 10 mM, or about 0.1 mM to 1 mM.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic illustration of conventional nitrate selective membranes (shown in the left and middle) and a nitrate selective membrane as described herein (shown in the right).

FIG. 2A is a 1H Nuclear Magnetic Resonance (NMR) spectrum of N,N,N-trioctyl-N-dec-9-en-1-ammonium bromide (1·Br).

FIG. 2B is a ¹³C Nuclear Magnetic Resonance (NMR) spectrum of N,N,N-trioctyl-N-dec-9-en-1-ammonium bromide (1·Br).

FIG. 3 shows differential scanning calorimetry (DSC) plots of single-component nitrate selective membrane with and without n-hexyl acrylate (nHA).

FIG. 4A is a plot of nitrate sensitivity performance of a conventional polyvinylidene chloride (PVC) nitrate selective electrode.

FIG. 4B is a plot of nitrate sensitivity performance of a single-component nitrate selective electrode as described herein.

FIG. 5A shows a comparison on nitrate sensitivity over time between a conventional nitrate selective electrode and a single-component nitrate selective electrode as described herein. The experiment was conducted under accelerated lifespan testing in deionized (DI) water at 80° C.

FIG. 5B shows a comparison on nitrate selectivity (against phosphate) over time between a conventional nitrate selective electrode and a single-component nitrate selective electrode as described herein. The experiment was conducted under accelerated lifespan testing in DI water at 80° C.

FIG. 5C shows a comparison on nitrate selectivity (against chloride) over time between a conventional nitrate selective electrode and a single-component nitrate selective electrode as described herein. The experiment was conducted under accelerated lifespan testing in DI water at 80° C.

FIG. 6 is a schematic illustration of conventional phosphate selective membranes (shown in the left and middle) and a phosphate selective membrane as described herein (shown in the right).

FIG. 7 is a DSC plot of a single-component monohydrogen phosphate selective membrane as described herein.

FIG. 8A is a plot of phosphate sensitivity performance of a single-component phosphate selective electrode as described herein, at pH 7.2.

FIG. 8B shows correlation between measured and theoretical electromotive force (EMF, derived from calibration curve) in 1 mM phosphate buffer solution at pH values from 5.5 to 8.5.

FIG. 9 is a schematic illustration of conventional potassium selective membranes (shown in the left and middle) and a potassium selective membrane as described herein (shown in the right).

FIG. 10 is a DSC plot of a single-component potassium selective membrane as described herein.

FIG. 11A is a plot of potassium sensitivity performance of a single-component potassium selective electrode as described herein.

FIG. 11B is a plot of potassium sensitivity performance of a two-component potassium selective electrode.

FIG. 12 shows a comparison of sensitivity performances between a single-component potassium selective electrode as described herein and a two-component potassium selective electrode. The corresponding experiment was conducted under accelerated lifespan testing in 1 mM potassium nitrate (KNO₃) solution at 80° C.

### DETAILED DESCRIPTION OF DRAWINGS

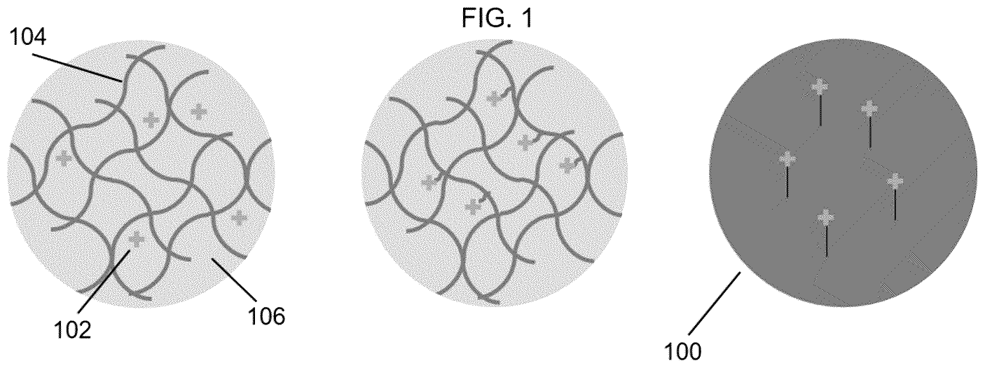

### FIG. 1

FIG. 1 is a schematic illustration of conventional nitrate selective membranes (shown in the left and middle) and a nitrate selective membrane as described herein (shown in the right). A conventional membrane is shown in the left where an ionic lipophilic additive (102) and a plasticizer (106) are suspended in a polymer matrix (104). An improved conventional membrane is shown in the middle where the plasticizer (106) is suspended in the polymer matrix (104) but the ionic lipophilic additive (102) is covalently attached to the polymer matrix (104). A single-component nitrate selective membrane as described herein (100) is shown in the right where the ionic lipophilic additive (102) is covalently attached to the polymer matrix (104) without any plasticizer.

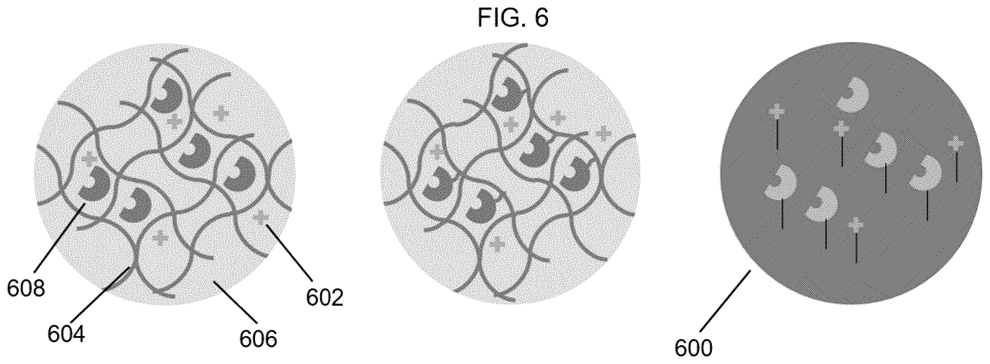

### FIG. 6

FIG. 6 is a schematic illustration of conventional phosphate selective membranes (shown in the left and middle) and a phosphate selective membrane as described herein (shown in the right). A conventional membrane is shown in the left where an ionic lipophilic additive (602), a plasticizer (606) and an ionophore (608) are suspended in a polymer matrix (604). An improved conventional membrane is shown in the middle where the plasticizer (606) and the ionic lipophilic additive (602) are suspended in the polymer matrix (604) but the ionophore (608) is covalently attached to the polymer matrix (604). A single-component phosphate selective membrane as described herein (600) is shown in the right where the ionic lipophilic additive (602) and the ionophore (608) are covalently attached to the polymer matrix (604) without any plasticizer.

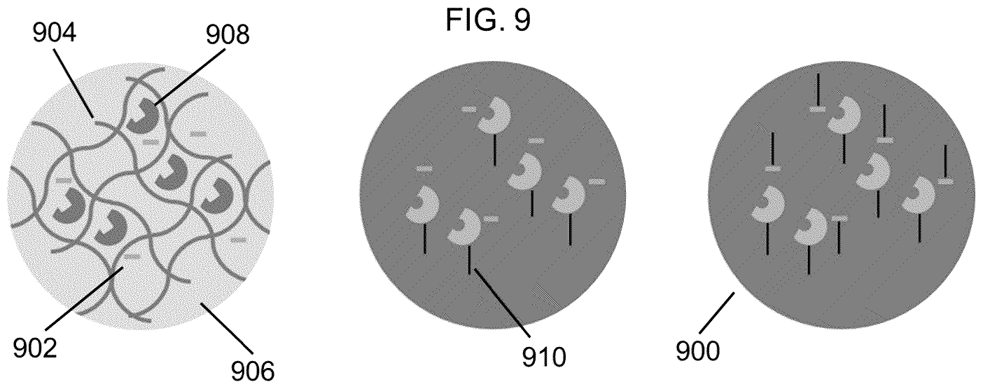

### FIG. 9

FIG. 9 is a schematic illustration of conventional potassium selective membranes (shown in the left and middle) and a potassium selective membrane as described herein (shown in the right). A conventional membrane is shown in the left where an ionic lipophilic additive (902), a plasticizer (906) and an ionophore (908) are suspended in a polymer matrix (904). An improved conventional membrane is shown in the middle where the plasticizer is absent, the ionic lipophilic additive (902) is suspended in the polymer matrix (904) and the ionophore (908) is attached to the polymer matrix (904) via covalent linkages (910). A single-component potassium selective membrane as described herein (900) is shown in the right where both the ionic lipophilic additive (902) and the ionophore (908) are attached to the polymer matrix (904) via covalent linkages (910) without any plasticizer.

### EXAMPLES

Non-limiting examples of the invention will be further described in greater detail by reference to specific Examples, which should not be construed as in any way limiting the scope of the invention.

### Example 1—Preparation of A Nitrate Selective Membrane

An overview of the procedures involved in this example is presented in Table 1 below.

TABLE 1
Overview of Experimental Procedures for
Preparing A Nitrate Selective Membrane

| Step | Process | Comments |
|---|---|---|
| 1 | Synthesize ionic | Reaction of trioctylamine with 10-bromo-1- |
| | lipophilic additive | decene under inert atmosphere and |
| | | anhydrous solvent at 60° C. for 3 weeks |
| 2 | Purify ionic lipophilic | Recrystallized from anhydrous diethyl ether |
| | additive | |
| 3 | Prepare membrane | Ionic lipophilic additive: N,N,N-trioctyl-N-dec- |
| | solution: 5-10 | 9-en-1-ammonium ion |
| | weight % of ionic | Base membrane |
| | lipophilic additive | Monomers: n-butyl acrylate (nBA) with up to |
| | 95-90 weight % of | 10 weight % n-hexyl acrylate (nHA) and/or 10 |
| | base membrane | weight % methyl methacrylate (MMA). |
| | | Cross linker: 0.1-1.0 weight % 1,6- |
| | | hexanediol diacrylate (HDDA) |
| | | Initiator: 1.1-1.2 weight % 2,2-dimethoxy-2- |
| | | phenylacetophenone (DMPP) |
| 4 | Prepare electrode by | Electrode materials: gold, gold with |
| | cleaning with acetone, | polyoctylthiophene, mesoporous carbon, |
| | isopropanol (if not | mesoporous carbon with polyaniline |
| | coated with conducting | |
| | polymer) | |
| 5 | Cast membrane | Dispense 3 μl for a 4 mm diameter circle |
| 6 | Cure membrane with | To form the membrane |
| | 405 nm LED at an | |
| | intensity of 20 mW/cm² | |
| | for 8 min under nitrogen | |
| 7 | Condition membrane in | To prepare the electrode for sensing |
| | 1 mM potassium nitrate | |
| | solution | |

### Example 2—Preparation of an Ionic Lipophilic Additive for Nitrate Selective Membrane

An ionic lipophilic additive N,N,N-trioctyl-N-dec-9-en-1-ammonium ion 1 (see below) is a quaternary alkyl ammonium cation which has high affinity for the nitrate ion; the alkene functional group enables immobilization of the ionic lipophilic additive. The ionic lipophilic additive is synthesized as its bromide salt (1·Br) for ease of purification and incorporation into the membrane formulation. The bromide ion can be exchanged for the nitrate ion during membrane conditioning.

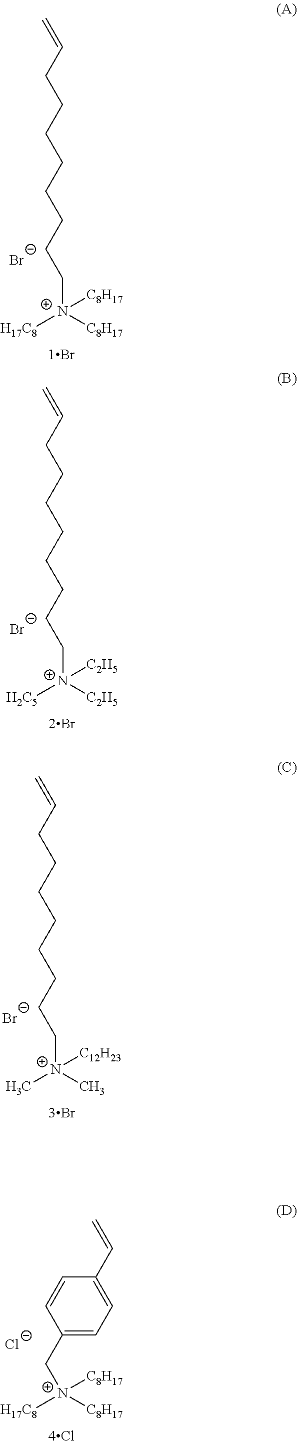

A representative example of the synthesis of N,N,N-trioctyl-N-dec-9-en-1-ammonium bromide (1·Br) is as follows:

To a solution of trioctylamine (2.19 mL, 5.00 mmol, purchased from Sigma-Aldrich, Singapore) in anhydrous acetone (20 mL, purchased from Acros Organics, Singapore) under argon atmosphere was added 10-bromo-1-decene (1.00 mL, 5.00 mmol, 1.0 equiv., purchased from TCI, Tokyo, Japan). The reaction mixture was sealed and stirred at 60° C. for 3 weeks. The solvent was removed in vacuo to afford the crude product (2.22 g, 3.88 mmol, 78%). The product was recrystallized from anhydrous diethyl ether (purchased from TCI, Tokyo, Japan) to yield colorless solid 1·Br (1.35 g, 2.36 mmol, 47%).

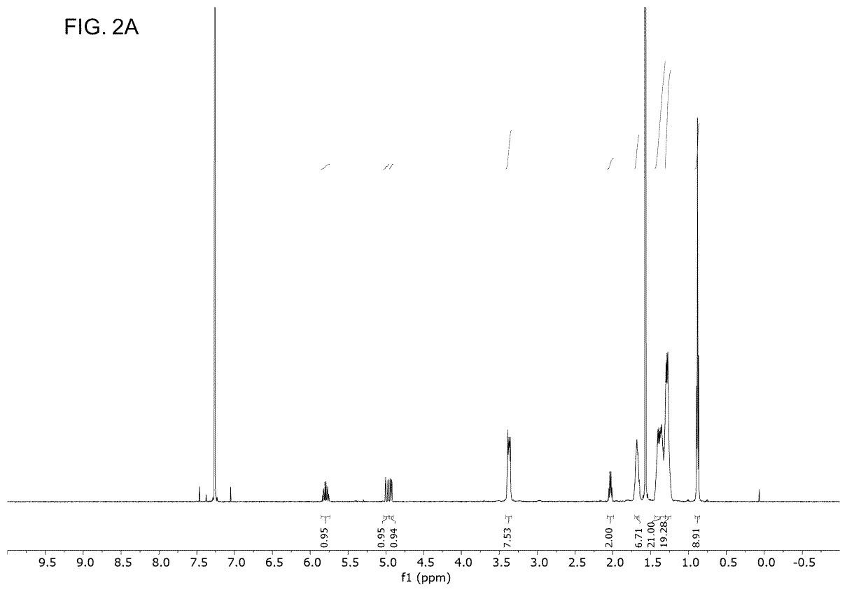

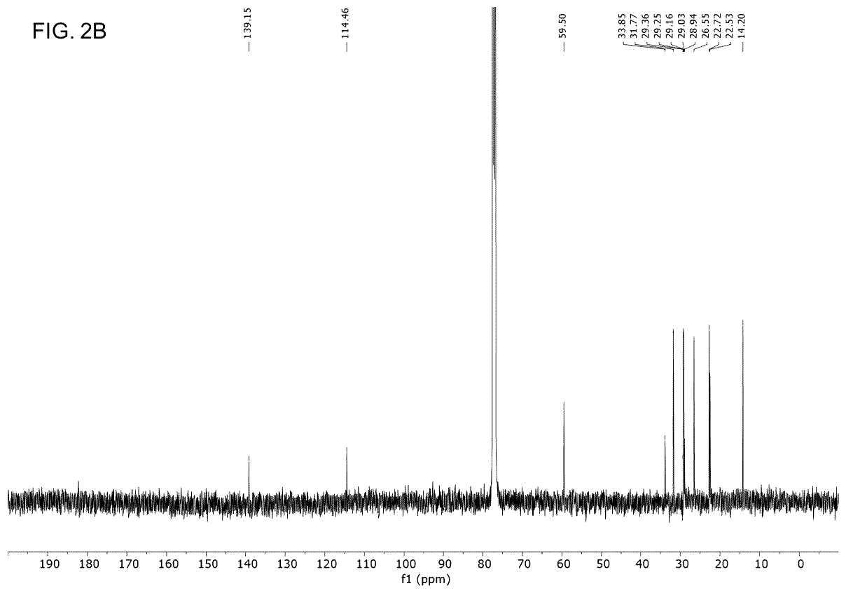

Nuclear magnetic resonance (NMR) spectroscopy was performed to characterize 1·Br (see FIGS. 2A and 2B), with the following data obtained:

¹H NMR (500 MHZ, Chloroform-d) δ 5.80 (ddt, J=17.0, 10.2, 6.7 Hz, 1H), 4.99 (dtt, J=17.0, 2.2, 1.6 Hz, 1H), 4.93 (ddt, J=10.2, 2.2, 1.2 Hz, 1H), 3.41-3.34 (m, 8H), 2.08-1.99 (m, 2H), 1.71-1.65 (m, 7H), 1.44-1.31 (m, 21H), 1.31-1.23 (m, 19H), 0.91-0.85 (m, 9H); ¹³C NMR (126 MHZ, Chloroform-d) δ 139.2, 114.5, 59.5, 33.9, 31.8, 29.4, 29.2, 29.2, 29.0, 28.9, 26.6, 22.7, 22.5, 14.2.

Several other compounds were synthesized by reaction of 10-bromo-1-decene with different tri-substituted amines e.g., N,N, N-triethyl-N-dec-9-en-1-ammonium bromide (2·Br), N,N-dimethyl-N-dodecyl-N-dec-9-en-1-ammonium bromide (3·Br) and N,N,N-trioctyl-N-(4-vinylbenzyl)-1-ammonium chloride (4·Cl). However, they were either too hydroscopic to function as ionic lipophilic additives (2 and 3) or did not show good sensitivity towards the nitrate ion (4).

### Example 3—Fabrication of a Single-Component Nitrate Selective Membrane

A cocktail of the single-component nitrate selective membrane was prepared by mixing 2.5-10 weight % of N,N,N-trioctyl-N-dec-9-en-1-ammonium bromide (1·Br, prepared in Example 2) into a base membrane which comprises of 2,2-dimethoxy-2-phenylacetophenone (DMPP, purchased from TCI, Tokyo, Japan) and 1,6-hexanediol diacrylate (HDDA, purchased from Alfa Aesar) in n-butyl acrylate (nBA, purchased from Sigma-Aldrich, Singapore) and/or co-monomer, n-hexyl acrylate (nHA, purchased from Sigma-Aldrich, Singapore) or methyl methacrylate (MMA, purchased from Sigma-Aldrich, Singapore). Key compositions of the nitrate selective membranes tested are as described in Table 2.

TABLE 2
Key Compositions of Single-component
Nitrate Selective Membranes Tested

| | 1•Br | DMPP | HDDA | nBA | nHA | MMA |
|---|---|---|---|---|---|---|
| | (weight | (weight | (weight | (weight | (weight | (weight |
| | %) | %) | %) | %) | %) | %) |
| Membrane | 10 | 1.1 | 0.1 | 88.8 | 0 | 0 |
| 1 | | | | | | |
| Membrane | 10 | 1.1 | 0.9 | 88.0 | 0 | 0 |
| 2 | | | | | | |
| Membrane | 5 | 1.1 | 0.1 | 93.8 | 0 | 0 |
| 3 | | | | | | |
| Membrane | 5 | 1.2 | 0.1 | 84.3 | 9.4 | 0 |
| 4 | | | | | | |
| Membrane | 5 | 1.2 | 0.1 | 84.3 | 0 | 9.4 |
| 5 | | | | | | |

A representative example of the preparation of Membrane 4 electrode is:

To 3.1 mg of DMPP in a glass vial that is protected from light was added 144 μL of nBA and 2.6 μL of HDDA. The base membrane mixture was stirred at room temperature until all solids dissolved.

To 5.0 mg of 1·Br was added 57 μL of base membrane mixture, 29 μL of nBA and 21 μL of nHA. The nitrate selective membrane cocktail was stirred at room temperature and stored in the fridge in the dark.

In a nitrogen-filled glovebox, 3 μL of the single component nitrate selective membrane cocktail was cast onto the polyaniline-coated screen-printed carbon electrode (4 mm diameter, Dropsens). The mixture was photocured under a 405 nm LED array at an intensity of 20 mW/cm² or under a UVA array (UVAHAND 250, Hönle UV technology) at a distance of 50 mm for 8 min. After membrane casting, the bromide ions from 1 were exchanged for nitrate ions by soaking in 0.1 M potassium nitrate solution (prepared from solid potassium nitrate salt purchased from VWR, Singapore) for at least 24 hours.

As a comparison, the conventional nitrate selective membrane with polyvinylidene chloride (PVC) was prepared as follows:

Tetradodecylammonium nitrate (5.0 mg, 5 weight %, purchased from Sigma-Aldrich, Singapore), PVC (47.7 mg, 47.7 weight %, purchased from Sigma-Aldrich) and 4-nitrophenyl octyl ether (42.4 mg, 42.4 weight %) were dissolved in THF (1 mL, purchased from Alfa Aesar, Singapore). 10 μL of the mixture was cast onto the electrode and the solvent was allowed to evaporate in situ at 20° C. for 1 hour, then in vacuo at 20° C. for 5 hours.

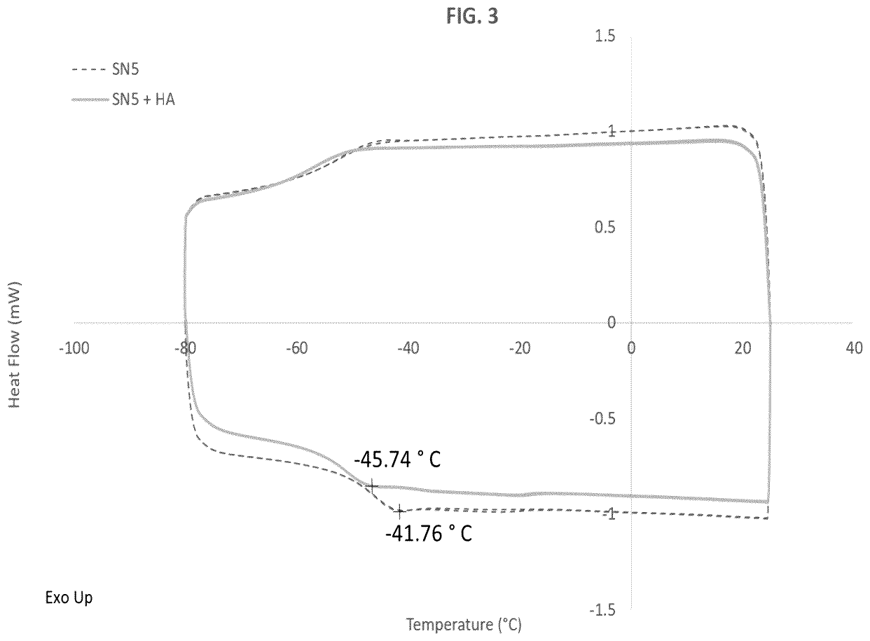

Glass transition temperature of the membranes were obtained via differential scanning calorimetry (DSC) using TA instruments DSC Q100. Membranes were deposited and cured or dried onto aluminum trays directly and sealed hermetically. The hermetically sealed pans were then cycled between 25° C. and −80° C. at a rate of 5° C./minute and the onset of the observed glass transition in the heating cycle was recorded as the glass transition temperature of the membrane. Polymers with glass transition temperature of less than −20° C. were self-plasticizing. Representative DSC plots of the membranes are as shown in FIG. 3. The glass transition temperatures of the membranes of the present disclosure were found to be between −45.7° C. to −41.8° C. which indicated that the membranes were self-plasticizing. In addition, only a single glass transition was observed for all membranes, suggesting that there was no phase separation within the membranes and the membranes were of a single component.

### Example 4—Performance of All-Solid-State Nitrate Selective Electrode

The nitrate selective membranes that were casted and cured onto an electrode as described in Example 3 formed all-solid-state nitrate selective electrodes.

Prior to testing, the all-solid-state nitrate selective electrodes were conditioned in 1 mM potassium nitrate solution for at least 16 hours. The conditioned electrodes were tested for their limit of detection, sensitivity to nitrate ion and selectivity against chloride and dihydrogen phosphate ions.

A potentiostat (mStat8000 Multi Potentiostat/Galvanostat, DRP-STAT8000) or a pH meter was used to measure the open circuit potential between the ion selective electrode and a reference electrode. The reference electrode used for the experiments was a double junction silver/silver chloride (Ag/AgCl) reference with 3 M potassium chloride (purchased from Metrohm, Singapore) as inner electrolyte and 1 M lithium acetate (purchased from Alfa Aesar, Singapore) as outer electrolyte. Both the ion selective electrode and reference electrode are placed in solutions of different concentrations of nitrate, chloride and dihydrogen phosphate ions (purchased from VWR, Singapore).

The sensitivity and limit of detection of the electrode were evaluated by measuring the open circuit potential between the two electrodes in potassium nitrate solutions with concentration ranging from 0.001 mM to 100 mM. The sensitivity corresponded to the change in potential per decade change in concentration and the limit of detection corresponded to the lowest concentration at which there was observable change in potential.

Selectivity of the electrode was evaluated using a fixed interference method in which the open circuit potential was measured when the electrodes were placed in solutions in which concentration of the interfering ions (chloride or monohydrogen phosphate) were fixed at 10 mM while the concentration of nitrate ions were varied from 0.001 mM to 100 mM.

A summary of the effect of membrane composition on the performance of the single component nitrate selective membrane is as follows:
Membranes with more cross-linker HDDA show slower response time (Membranes 2 and 1)
Membranes with 5 and 10 weight % ionic lipophilic additive 1·Br have comparable performances (Membranes 3 and 1)
Membranes with 9.4 weight % nHA co-monomer have better selectivity and limit of detection than membranes with only nBA monomer (Membranes 4 and 3)
Membranes with 9.4 weight % MMA co-monomer have poorer selectivity than membranes with only nBA monomer (Membranes 5 and 3)

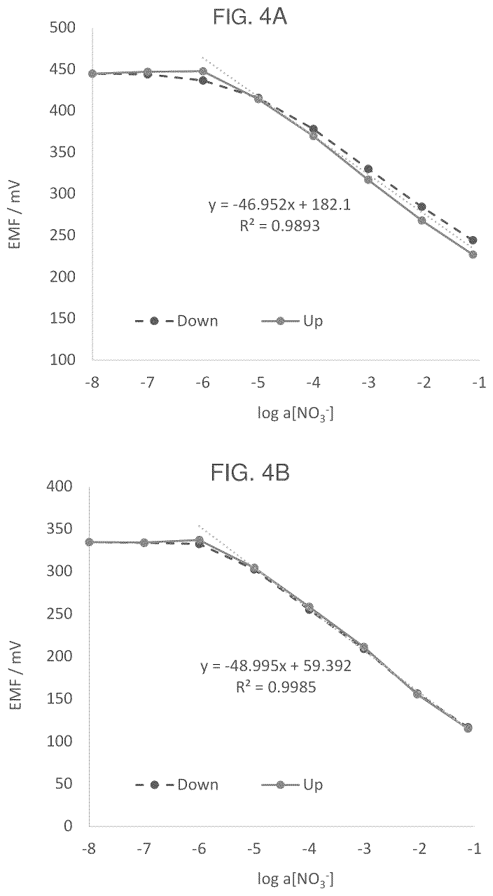

A representative plot of the nitrate sensitivity performance of the single-component electrode of the present disclosure (Membrane 4) in comparison to the conventional PVC electrode is shown in FIGS. 4A and 4B. For the single-component electrode of the present disclosure, sensitivity to nitrate was −49 mV/decade, which was close to the theoretical value of −59 mV/dec governed by Nernst law. The electrodes also had a response within 30 seconds of a change in nitrate concentration, and the limit of detection was 0.0016 mM. All the values measured were comparable to the conventional PVC electrode (see Table 3), and the hysteresis observed between the calibration curves (up and down representing increase and decrease in concentrations) was less for the electrode of the present disclosure compared to the conventional electrode, also evidenced by the better R² value of the sensitivity slope. This indicated that the single-component electrode of the present disclosure provided greater consistency and reliability in the measured nitrate concentrations.

A comparison of the key characteristics of the conventional and single-component nitrate selective electrodes in shown in Table 3. In comparison to the conventional membrane, the membrane of the present disclosure had comparable selectivity for nitrate against chloride (Cl⁻), and a significantly better selectivity for nitrate against hydrogen phosphate (HPO₄²⁻).

TABLE 3
Key Characteristics of Conventional and Single-component
(Membrane 4) Nitrate Selective Electrodes

| Characteristic | Conventional | Single Component |
|---|---|---|
| Sensitivity Slope/ | −47 | −49 |
| mV decade⁻¹ | | |
| Limit of detection/ | −5.7 | −5.8 |
| log a[NO₃⁻] | (0.002 mM) | (0.0016 mM) |
| Selectivity vs. Cl⁻/ | −2.5 | −2.4 |
| log K[NO₃, Cl] | (300 × more | (250 × more |
| | selective for | selective for |
| | NO₃⁻) | NO₃⁻) |
| Selectivity vs. HPO₄²⁻/ | −2.0 | −2.7 |
| log K[NO₃, HPO₄] | (100 × more | (500 × more |
| | selective for | selective for |
| | NO₃⁻) | NO₃⁻) |

To determine the lifespan of the electrodes, accelerated testing was performed by soaking the all-solid-state electrodes in deionized (DI) water at 80° C. for a period of 2 weeks while measuring the electrodes' performance after every 24-72 hours. Prior to performance testing, the electrodes were reconditioned in 1 mM potassium nitrate solution for 16 hours and the test was performed at room temperature. The accelerated test speeded up the degradation process by about 45 times, i.e., electrodes which performed well after 1 day under accelerated conditions are expected to retain their performance for 1.5 months at 25° C.

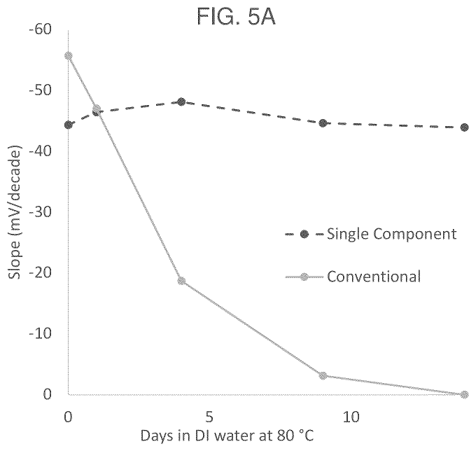

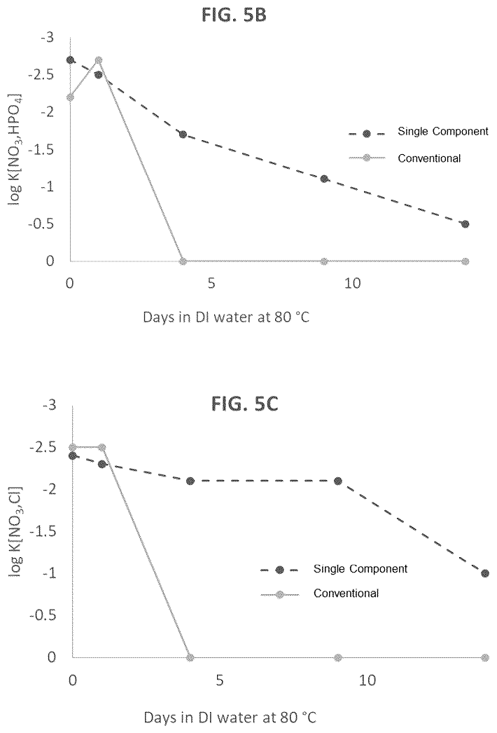

Representative plots of the accelerated testing performance of the single-component electrode of the present disclosure (Membrane 4) in comparison to the conventional PVC electrode are shown in FIGS. 5A to 5C. The conventional electrode already began losing nitrate sensitivity after 24 hours and continued to deteriorate to zero after 2 weeks of soaking. In contrast, the single-component electrode of the present disclosure maintained its sensitivity towards nitrate throughout the entire duration of testing. The nitrate selectivity of both electrodes diminished over time. However, while the conventional electrode's nitrate selectivity drastically deteriorated between 1 to 4 days, the single-component electrode of the present disclosure experienced a slow deterioration in selectivity and was still 10 times more selective for nitrate over interfering ions after 9 days in DI water at 80° C. This represented continuous usage of the single-component electrode for more than 1 year; in contrast, conventional ion-selective electrodes typically have a lifespan of 6 months (non-continuous usage). It should be noted however, that these results represent a ‘worst-case scenario’, and smaller losses of electrode's nitrate selectivity could be expected when deployed under actual field settings. It is very likely that the excessively harsh conditions of the accelerated lifespan tests (80° C.) can cause damage to the membrane of the present disclosure that would not be expected under ambient conditions in the field, where temperatures are not expected to exceed 45° C.

### Example 5—Preparation of a Phosphate Selective Membrane

An overview of the procedures involved in this example is presented in Table 4 below.

TABLE 4
Overview of Experimental Procedures for
Preparing A Phosphate Selective Membrane

| Step | Process | Comments |
|---|---|---|
| 1 | Synthesize | Synthesis from commercially available 5- |
| | monohydrogen | hydroxyisophthalic acid, 10-bromo-1-decene, |
| | phosphate ionophore | isophthalic acid and (1R,2R)-(+)-1,2- |
| | | diphenylethylenediamine. |
| 2 | Synthesize cationic | Reaction of dimethylhexadecylamine with 10- |
| | lipophilic salt | bromo-1-decene under inert atmosphere and |
| | | anhydrous solvent at 60° C. for 3 days. |
| 3 | Prepare membrane | Monohydrogen phosphate ionophore: |
| | solution: | (4R,5R,11R,12R)-15-(dec-9-en-1-yloxy)-4,5,11,12- |
| | 2.5-12 weight % of | tetraphenyl-3,6,10,13-tetraaza-1,8(1,3)- |
| | phosphate ionophore | dibenzenacyclotetradecaphane-2,7,9,14-tetraone |
| | 1.5-7.0 weight % of | 10; |
| | cationic lipophilic salt | Cationic lipophilic salt: N-(dec-9-en-1-yl)-N,N- |
| | 96-88 weight % of | dimethyl-N-hexadecyl-1-ammonium bromide 11•Br |
| | base membrane | Base membrane |
| | | Monomers: n-butyl acrylate (nBA) with up to 10 |
| | | weight % methyl methacrylate (MMA) |
| | | Cross linker: 0.1 weight % 1,6-hexanediol diacrylate |
| | | (HDDA) |
| | | Initiator: 1.2 weight % 2,2-dimethoxy-2- |
| | | phenylacetophenone (DMPP) |
| 4 | Cast and UV cure | Dispense 3 μl for a 4 mm diameter circle; UV cure |
| | membrane cocktail | with 405 nm LED at an intensity of 20 mW/cm² for |
| | | 15 min under nitrogen |
| 5 | Perform ion | Ion exchange solution: 0.1M potassium phosphate |
| | exchange and | (pH 8) buffer |
| | conditioning in | Conditioning solution: 1 mM potassium phosphate |
| | potassium phosphate | (pH 7.2) buffer |
| | buffer | |

### Example 6—Preparation of an Ionophore for Phosphate Selective Membrane

An ionophore (4R,5R,11R,12R)-15-(dec-9-en-1-yloxy)-4,5,11,12-tetraphenyl-3,6,10,13-tetraaza-1,8 (1,3)-dibenzenacyclotetradecaphane-2,7,9,14-tetraone 10 is a macrocyclic tetramide molecule which has high affinity for the monohydrogen phosphate (HPO₄²⁻) ion; the alkene functional group enables immobilization of the ionophore.

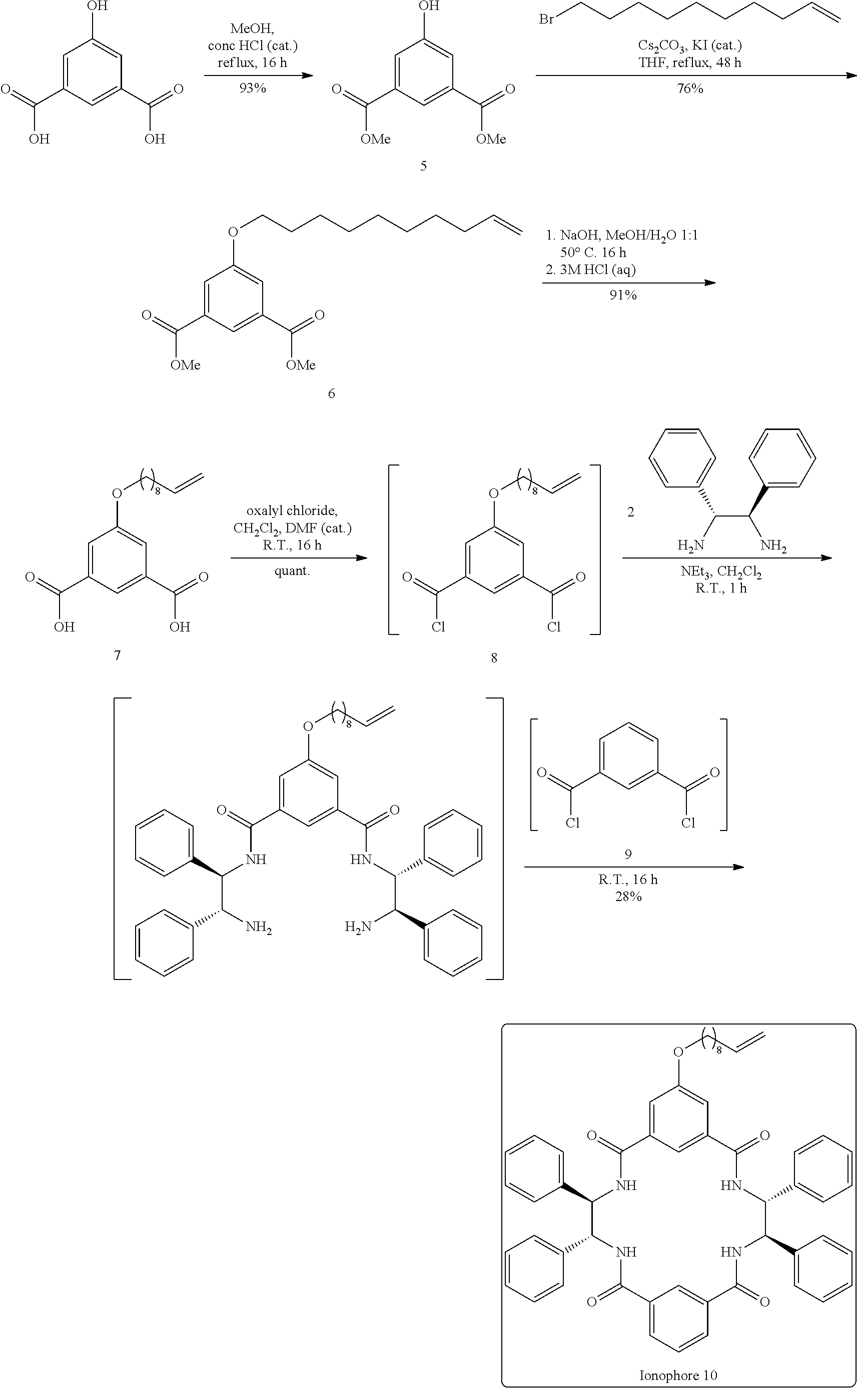

A representative example of the synthesis of monohydrogen phosphate ionophore 6 is shown below:

### Dimethyl-5-hydroxyisophthalate 5

Commercially available 5-hydroxyisophthalic acid (2.00 g, 11.0 mmol, purchased from Sigma-Aldrich, Singapore) was dissolved in methanol (60 mL, purchased from J. T. Baker, Singapore) to form a colourless solution. After 5 drops of conc. hydrochloric acid (purchased from Honeywell, North Carolina, United States) was added, the reaction was heated under reflux for 16 hours. Removal of the solvent in vacuo afforded the product 5 as a white crystalline solid (2.15 g, 93%), with no further purification necessary. ¹H NMR (CDCl₃, 500 MHZ) 8.24 (2H, s, ArH), 7.74 (1H, s, ArH), 3.93 (6H, s, COOCH₃).

### Dimethyl-5-(dec-9-en-1-yloxy) isophthalate 6

Intermediate 5 (0.85 g, 4.04 mmol) was mixed with cesium carbonate (1.98 g, 6.09 mmol, purchased from Alfa Aesar, Singapore) and potassium iodide (134 mg, 0.81 mmol, purchased from GCE Lab Chemicals, Malmö, Sweden). Anhydrous THF (16 mL, purchased from Acros Organics, Singapore) was added and 10-bromo-1-decene (0.80 mL, 4.26 mmol, purchased from TCI, Tokyo, Japan) was added portionwise to the vigorously stirred mixture. The reaction was heated under reflux under an inert Ar atmosphere for 48 hours to give a beige suspension. After cooling to ambient conditions, THF was removed on a rotary evaporator. Deionised water (30 mL) was added and the mixture was stirred till a uniform suspension was obtained. Thereafter, the aqueous mixture was extracted with diethyl ether 3 times and the combined organics were washed with brine and dried with anhydrous magnesium sulfate. Solvent removal afforded a brown liquid which was purified using silica gel column chromatography (eluent: 1:1 hexane/dichloromethane, then pure dichloromethane) to obtain the product as a colourless sticky liquid (1.07 g, 76%). ¹H NMR (CDCl₃, 500 MHz) 8.25 (1H, s, ArH), 7.72 (2H, s, ArH), 5.76-5.77 (1H, m, CH═CH₂), 4.89-5.00 (2H, m, CH═CH₂), 4.02 (2H, t, ³J=7.6 Hz, OCH₂), 3.92 (6H, s, COOCH₃), 2.03 (2H, quart., ³J=7.2 Hz, CH₂CH═CH₂), 1.79 (2H, quint., ³J=6.9 Hz, OCH₂CH₂), 1.30-1.48 (10H, m, alkyl-H).

### 5-(dec-9-en-1-yloxy) isophthalic acid 7

To a solution of compound 6 (150 mg, 0.43 mmol) in methanol (2 mL) was added 3.9 M aqueous sodium hydroxide (8.6 mL, purchased from Merck KGaA, Darmstadt, Germany) and the solution heated at 50° C. overnight. The reaction was monitored by thin layer chromatography (eluent: 1:9 methanol/dichloromethane v/v), and upon complete hydrolysis, the solution was poured into 3 M HCl (aqueous, 50 mL, purchased from diluted from concentrated HCl obtained from Honeywell, North Carolina, United States) to form a white suspension. The suspension was extracted with ethyl acetate (3×25 mL) and the combined organics were dried with MgSO₄. Solvent removal in vacuo gave the product 3 as a white solid in excellent purity (125 g, 91%). ¹H NMR (de-acetone, 500 MHZ) 8.24 (1H, s, ArH), 7.73 (2H, s, ArH), 5.74-5.83 (1H, m, CH═CH₂), 4.86-4.97 (2H, m, CH═CH₂), 4.12 (2H, t, ³J=7.8 Hz, OCH₂), 2.02 (2H, quart., ³J=7.8 Hz, CH₂CH═CH₂), 1.80 (2H, quint., ³J=7.4 Hz, OCH₂CH₂), 1.31-1.53 (10H, m, alkyl-H).

### 5-(dec-9-en-1-yloxy) isophaloyl dichloride 8

Compound 7 (125 mg, 0.39 mmol) was suspended in anhydrous dichloromethane (2 mL) and one drop of anhydrous N, N′-dimethylformamide was added. To the vigorously-stirred suspension was added oxalyl chloride (0.05 mL, 0.59 mmol, purchased from Sigma-Aldrich, Singapore) dropwise, during which vigorous effervescence was seen. The reaction was left to proceed overnight at room temperature to form a pale-yellow solution before the solvent was removed in vacuo to yield the product 8 as a pale-yellow solid. Due to the moisture sensitivity of the product, it was used immediately in the assembly of the ionophore 10 without further purification and characterisation.

### Isophthaloyl dichloride 9

The same procedure as that for compound 8 was followed, except that acid 7 was replaced with commercially-available isophthalic acid (5 mg, 0.39 mmol, purchased from Sigma-Aldrich, Singapore).

### Monohydrogen phosphate ionophore 10

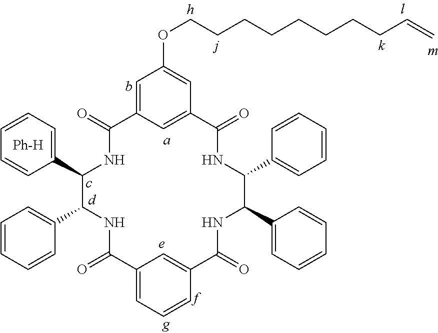

Triethylamine (0.29 mL, 5.3 mmol, purchased from Sigma-Aldrich, Singapore) and commercially-available (1R,2R)-(+)-1,2-diphenylethylenediamine (166 mg, 0.78 mmol, purchased from TCI, Singapore) were dissolved in anhydrous dichloromethane (70 mL). Compound 8 was dissolved in the same solvent (5 mL) and added portionwise to the vigorously-stirred amine solution. After stirring for 30 minutes at room temperature, a dichloromethane solution (5 mL) of compound 9 was added and the reaction left to stir under a dry Ar atmosphere overnight. The reaction was concentrated till c.a. 5 mL, and was immediately purified by silica gel column chromatography (eluent: 15% ethyl acetate in dichloromethane v/v). The product was isolated as an off-white powder (92 mg, 28%). ¹H NMR (CDCl₃, 500 MHZ) 8.39 (1H, s, Hₑ), 8.03 (4H, m, CONH), 7.94 (1H, s, Hₐ), 7.66 (2H, d, ³J=7.6 Hz, H_{f}), 7.16-7.34 (23H, m, H_{b+g} & Ph-H), 5.76 (1H, m, Hₗ), 5.59 (4H, m, H_{c+d}), 4.92 (2H, m, Hₘ), 3.90 (2H, m, Hₙ), 1.99 (2H, m, Hₖ), 1.70 (2H, m, Hⱼ), 1.25-1.42 (10H, m, alkyl-H); ESI-MS 839.5 [M+H]⁺ (predicted 838.4 for C₅₄H₅₄N₄O₅).

### Example 7—Preparation of Cationic Lipophilic Salt for Phosphate Selective Membrane

A cationic lipophilic salt N-(dec-9-en-1-yl)-N,N-dimethyl-N-hexadecyl-1-ammonium 11 (see below) is a quaternary alkyl ammonium cation which acts as an anion exchanger; the alkene functional group enables immobilization of the lipophilic salt. The lipophilic salt was synthesized as its bromide salt (11·Br) for ease of purification and incorporation into the membrane formulation. The bromide ion can be exchanged for the monohydrogen phosphate ion during membrane conditioning.

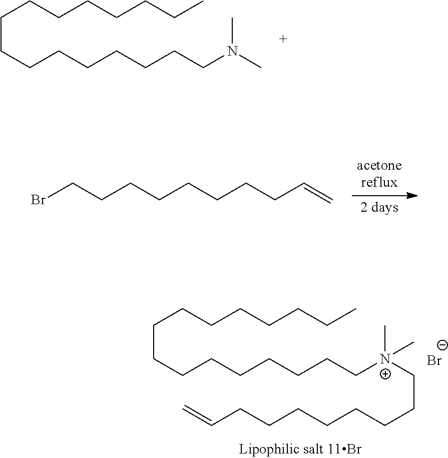 [SMILES: CCCCCCCCCCCCCCCCN(C)C ; C=CCCCCCCCCBr ; C=CCCCCCCCC[N+](C)(C)CCCCCCCCCCCCCCCC ; [Br-]]

A representative example of the synthesis of N-(dec-9-en-1-yl)-N,N-dimethyl-N-hexadecyl-1-ammonium bromide 11·Br is shown below:

To a solution of dimethylhexadecylamine (0.33 mL, 1.00 mmol, purchased from Sigma-Aldrich, Singapore) in anhydrous acetone (2 mL) under argon atmosphere was added 10-bromo-1-decene (0.22 mL, 1.00 mmol, 1.1 equiv., purchased from TCI, Tokyo, Japan). The reaction mixture was sealed and stirred at 60° C. for 2 days. Anhydrous diethyl ether was added to precipitate off-white solid 11·Br (414 mg, 0.957 mmol, 96%) which was filtered under argon. ¹H NMR (CDCl₃, 500 MHZ) δ 5.80 (1H, ddt, J=16.9, 10.2, 6.7 Hz, CH═CH₂), 4.99 (1H, dq, J=17.1, 1.7 Hz, CH═CH₂), 4.93 (1H, ddt, J=10.1, 2.3, 1.3 Hz, CH═CH₂), 3.55-3.46 (4H, m, NCH₂CH₂), 3.40 (6H, s, CH₃), 2.07-1.99 (2H, m, CH₂CH═CH₂), 1.69 (4H, app dt, J=15.2, 7.5 Hz, NCH₂CH₂), 1.62 (2H, m, alkyl-H), 1.41-1.32 (10H, m, alkyl-H), 1.31-1.26 (8H, m, alkyl-H), 1.25 (18H, m, alkyl-H), 0.87 (t, J=6.9 Hz, 3H, CH₂CH₃); ¹³C NMR (CDCl₃, 126 MHZ) δ 139.1, 114.5, 64.1, 51.4, 33.8, 32.1, 29.9, 29.8, 29.8, 29.8, 29.7, 29.6, 29.5, 29.3, 29.3, 29.3, 29.0, 28.9, 26.4, 26.4, 22.9, 22.8, 14.3.

### Example 8—Preparation of Single-Component Monohydrogen Phosphate Selective Membrane

A cocktail of the single-component phosphate selective membrane was prepared by mixing 2.5-12 weight % of monohydrogen phosphate ionophore 10 and 50-125 mol % of cationic lipophilic salt 11·Br with 2,2-dimethoxy-2-phenylacetophenone (DMPP, 1.2 weight %) and 1,6-hexanediol diacrylate (HDDA, 0.1 weight %) in n-butyl acrylate (nBA) and/or methyl methacrylate (MMA). Key compositions of the phosphate selective membranes tested are described in Table 5 below.

TABLE 5
Key Compositions of Single-component Monohydrogen
Phosphate Selective Membranes Tested

| | Ionophore 10 | 11•Br | nBA | MMA |
|---|---|---|---|---|
| | (weight %) | (weight %) | (weight %) | (weight %) |
| Membrane 1 | 5 | 1.5 | 92.2 | 0 |
| Membrane 2 | 5 | 2.2 | 91.5 | 0 |
| Membrane 3 | 5 | 2.9 | 90.8 | 0 |
| Membrane 4 | 5 | 3.6 | 90.1 | 0 |
| Membrane 5 | 5 | 2.9 | 81.7 | 9.1 |
| Membrane 6 | 5 | 2.9 | 72.6 | 18.2 |
| Membrane 7 | 2.5 | 1.5 | 85.2 | 9.5 |
| Membrane 8 | 8 | 4.6 | 77.5 | 8.6 |
| Membrane 9 | 12 | 7.0 | 71.7 | 8.0 |

A representative example of the preparation of Membrane 5 electrode is shown below:

To 3.1 mg of DMPP in a glass vial that is protected from light was added 144 μL of nBA and 2.6 μL of HDDA. The base membrane mixture was stirred at room temperature until all solids dissolved.

To 5.0 mg of ionophore 10 was added 2.9 mg of cationic lipophilic salt 11·Br, 57 μL of base membrane mixture, 36.4 μL of nBA and 9.6 μL of MMA. The phosphate selective membrane cocktail was stirred at room temperature and stored in a fridge in the dark.

All membrane cocktails were cast onto polyaniline-coated screen-printed carbon electrode (4 mm diameter, Dropsens) as follows:

In a nitrogen-filled glovebox, 3 μL of the single-component monohydrogen phosphate selective membrane cocktail was cast onto the electrode. The mixture was photocured under a 405 nm LED array at an intensity of 20 mW/cm² or under a UVA array (UVAHAND 250, Hönle UV technology) at a distance of 50 mm for 15 minutes. After membrane casting, the bromide ions from lipophilic salt 11·Br were exchanged for monohydrogen phosphate ions by soaking in 0.1 M potassium phosphate buffer (pH 8, prepared from solid potassium dihydrogen phosphate and potassium monohydrogen phosphate salts, both purchased from VWR, Singapore) solution for at least 24 hours.

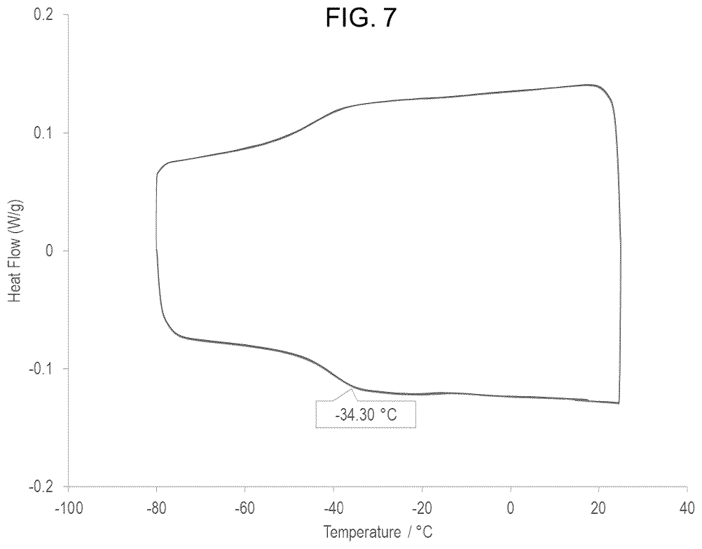

Glass transition temperature of the membranes were obtained via differential scanning calorimetry (DSC) using TA instruments DSC Q100. Membranes were deposited and cured or dried onto aluminum trays directly and sealed hermetically. The hermetically sealed pans were then cycled between 25° C. and −80° C. at a rate of 5° C./minute and the onset of the observed glass transition in the heating cycle was recorded as the glass transition temperature of the membrane. Polymers with glass transition temperature of less than −20° C. were self-plasticising. A representative DSC plot of the single-component monohydrogen phosphate selective membrane of the present disclosure (membrane 5) is shown in FIG. 7. The glass transition temperatures of the membrane of the present disclosure were found to be −34.3° C. which indicated that the membrane was self-plasticising. In addition, only a single glass transition was observed for the membrane, suggesting that there was no phase separation within the membrane and the membrane was of a single component.

### Example 9—Performance of All-Solid-State Monohydrogen Phosphate Selective Electrode

The monohydrogen phosphate selective membranes that were casted and cured onto an electrode as described in Example 8 formed all-solid-state nitrate selective electrodes.

Prior to testing, the all-solid-state phosphate selective electrodes were conditioned in 1 mM potassium phosphate buffer (pH 7.2, prepared from solid potassium dihydrogen phosphate and potassium monohydrogen phosphate salts, both purchased from VWR, Singapore) solution for at least 16 hours. The conditioned electrodes were tested for their limit of detection, sensitivity to monohydrogen phosphate ion and selectivity against sulphate, nitrate and chloride ions.

A potentiostat (mStat8000 Multi Potentiostat/Galvanostat, DRP-STAT8000) or a pH meter was used to measure the open circuit potential between the ion selective electrode and a reference electrode. The reference electrode used for the experiments was a double junction silver/silver chloride (Ag/AgCl) reference with 3 M potassium chloride as inner electrolyte and 1 M lithium acetate as outer electrolyte. Both the ion selective electrode and reference electrode were placed in solutions of different concentrations of phosphate, chloride and dihydrogen phosphate ions.

The sensitivity and limit of detection of the electrode were evaluated by measuring the open circuit potential between the two electrodes in potassium phosphate buffer (pH 7.2) solutions with concentration ranging from 0.0001 mM to 500 mM. The sensitivity corresponded to the change in potential per decade change in concentration and the limit of detection corresponded to the lowest concentration at which there was observable change in potential, which was defined as the point of the intersection between a linear extrapolation of the Nernstian slope, and the horizontal part of the upper curve where the EMF was a constant value.

Based on IUPAC recommendations, the selectivity of the electrode against divalent anions was evaluated using the fixed interference method (FIM), while selectivity against monovalent anions was evaluated using the matched potential method (MPM) as follows:

Selectivity of the electrode against divalent anion sulphate was evaluated using FIM in which the open circuit potential was measured when the electrodes were placed in solutions in which concentration of the interfering ion (sulphate) was fixed at 0.1 mM while the concentration of monohydrogen phosphate ions were varied from 0.001 mM to 100 mM.

Selectivity of the electrode against monovalent anions nitrate and chloride was evaluated using MPM in which the open circuit potential was measured when the electrodes were placed in solutions in which concentration of the primary ion (monohydrogen phosphate) was fixed at 0.05 mM while the concentration of interfering ion (nitrate or chloride) was varied from 0.05 mM to 1 mM.

As phosphate speciation was affected by pH in the following equation:

$${H}_{2} {PO}_{4}^{-} ⇌ {H}^{+} + {HPO}_{4}^{2 -} \qquad pKa = 7.21$$

the performance of the monohydrogen phosphate selective electrode was evaluated across a range of pH (5.5 to 8.5) at 1 mM total phosphate concentration. The solution pH was controlled by adjusting the ratios of potassium dihydrogen orthophosphate (KH₂PO₄) to dipotassium monohydrogen phosphate (K₂HPO₄) and monitoring with a pH electrode (OrionStar A111 benchtop PH meter with Orion ROSS Ultra low maintenance pH/ATC triode 8107BNUMD).

The theoretical EMF of each test solution was calculated from the monohydrogen phosphate activity of the test solution, itself derived from total phosphate concentration, pH, Henderson-Hasselbach equation and Debye-Hückel limiting law, and the monohydrogen phosphate sensitivity calibration curve was obtained at pH 7.2. The experimental EMF was then regressed on the theoretical EMF to evaluate the pH dependency of the electrode.

A summary of the effect of membrane composition on the performance of the single component phosphate selective membrane is as follows:
Membranes with more lipophilic salt (up to 125 mol %) showed less hysteresis (Membranes 1 to 4); membranes with no lipophilic salt or with mobile lipophilic salt tridodecylmethylammonium chloride (up to 125 mol %) did not function as well
Membranes with 9.4 or 18.4 weight % MMA co-monomer had better selectivity than membranes with only nBA monomer (Membranes 3, 5 and 6)
Membranes with 5 weight % ionophore had less hysteresis than membranes with 8 or 12 weight % ionophore; membranes with 2.5 weight % ionophore did not respond (Membranes 5, 7 to 9)

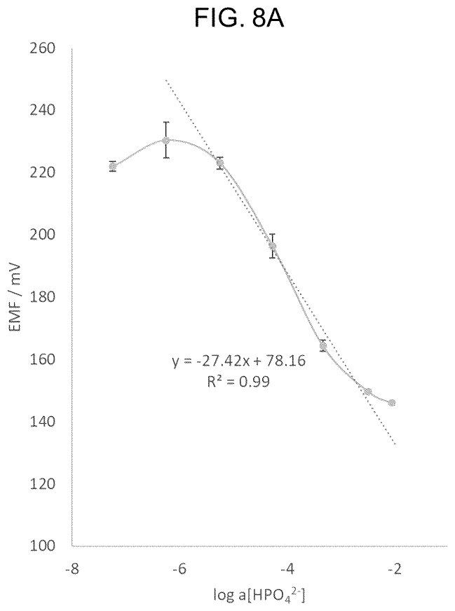

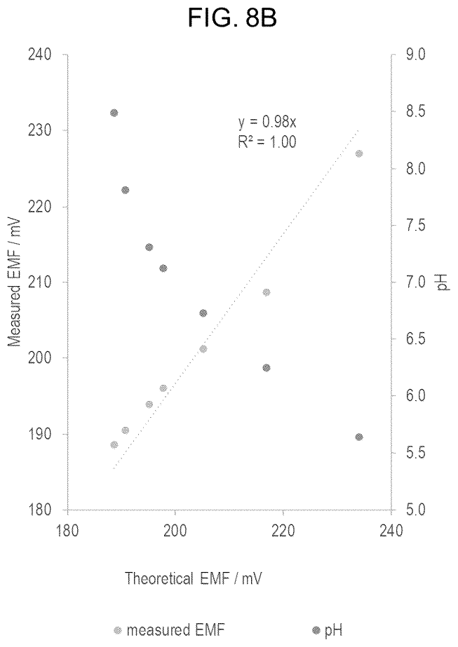

A representative plot of the monohydrogen phosphate sensitivity performance of the single-component electrode is shown in FIG. 8A. For the single-component electrode, sensitivity to phosphate was −27.4 mV/decade, which was close to the theoretical maximum of −29 mV/dec governed by Nernst law, and the limits of detection were 0.0025 mM (lower limit) and 3.9 mM (upper limit). Both values were comparable to the immobilised PVC-based electrode known in the art. The good correlation between the measured and predicted EMFs from pH 5.5 to 8.5 (see FIG. 8B) also indicated that the single-component electrode responded to monohydrogen phosphate over this range.

A comparison of the key characteristics of a conventional phosphate selective electrode and the single-component phosphate selective electrode of the present disclosure is shown in Table 6.

In comparison to the conventional electrode, the single-component electrode had poorer selectivity for monohydrogen phosphate against chloride (Cl⁻), but better selectivity for monohydrogen phosphate against nitrate (NO₃⁻) and sulfate (SO₄²⁻). The latter two ions contributed significant interference for divalent anion selective membranes, especially in agricultural soil or solution samples. In addition, the membrane of the present disclosure retained its sensitivity performance within the tested pH range of 5.5 to 8.5, which was larger than that that of the conventional membrane (pH 6 to 8), and maintained its performance for more than 100 days of usage.

TABLE 6
Key characteristics of conventional and single component
(Membrane 5) phosphate selective electrodes

| | | Immobilised (Le Goff et |
|---|---|---|
| Characteristic | Single Component | al.)² |
| Sensitivity Slope/ | −27.4 | −29.7 |
| mV decade⁻¹ | | |
| Detection Range/ | −5.6 to −2.5 | −6.0 to −2.4 |
| log a[HPO₄²⁻] | (0.002 to 3.2 mM) | (0.001 to 3.9 mM) |
| Selectivity vs. SO₄²⁻ | −0.30 | −0.22 |
| (FIM)/ | (2.0 × selective for HPO₄²⁻) | (1.6 × selective for HPO₄²⁻) |
| log K[HPO₄, SO₄] | | |
| Selectivity vs. NO₃⁻ | −0.59 | −0.30 |
| (MPM)/ | (3.9 × selective for HPO₄²⁻) | (2.0 × selective for HPO₄²⁻) |
| log K^{MPM}[HPO₄, NO₃] | | |
| Selectivity vs. Cl⁻ | −0.81 | −1.0 |
| (MPM)/ | (6.4 × selective for HPO₄²⁻) | (10 × selective for HPO₄²⁻) |
| log K^{MPM}[HPO₄, Cl] | | |
| pH range | At least 5.5 to 8.5 | 6 to 8 |
| Lifespan | >100 days | 40 days |

### Example 10—Preparation of a Potassium Selective Membrane

An overview of the procedures involved in this example is presented in Table 7 below.

TABLE 7
Overview of Experimental Procedures for
Preparing A Potassium Selective Membrane

| Step | Process | Comments |
|---|---|---|
| 1 | Synthesize | Synthesis from commercially available 1-aza-18- |
| | potassium ionophore | crown-6 and 10-bromo-1-decene. |
| 2 | Prepare membrane | Potassium ionophore: 1-(1,4,7,10,13-pentaoxa-16- |
| | solution: | azacyclooctadecan-16-yl)hex-5-en-1-one 12; |
| | 2-2.5 weight % of | Anionic lipophilic salt: 2-acrylamido-2-methyl-1- |
| | potassium ionophore | propanesulfonic acid 13 |
| | 0.1-1.2 weight % of | Base membrane |
| | anionic lipophilic salt | Monomers: n-butyl acrylate (nBA) with up to 20 |
| | 96-95 weight % of | weight % methyl methacrylate (MMA) or |
| | base membrane | tetrahydrofurfurylacrylate (THFA) |
| | | Cross linker: 0.1 weight % 1,6-hexanediol diacrylate |
| | | (HDDA) |
| | | Initiator: 1.2 weight % 2,2-dimethoxy-2- |
| | | phenylacetophenone (DMPP) |
| 3 | Cast and UV cure | Dispense 3 μl for a 4 mm diameter circle; UV cure |
| | membrane cocktail | with 405 nm LED at an intensity of 20 mW/cm² for |
| | | 15 min under nitrogen |
| 4 | Perform ion | Ion exchange solution: 0.1M potassium nitrate |
| | exchange and | solution |
| | conditioning in | Conditioning solution: 1 mM potassium nitrate |
| | potassium nitrate | solution |
| | solution | |

### Example 11—Preparation of an Ionophore for Potassium Selective Membrane

The ionophore 1-(1,4,7,10,13-pentaoxa-16-azacyclooctadecan-16-yl) hex-5-en-1-one 12 (see below) is a crown other molecule which has high affinity for the potassium (K⁺) ion; the alkene functional group enables immobilization of the ionophore.

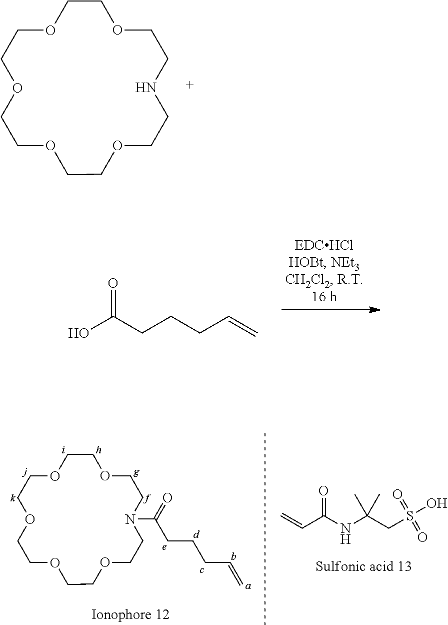

A representative example of the synthesis of potassium ionophore 12 is shown as follows:

5-Hexenoic acid (0.18 mL, 1.5 mmol, purchased from TCI, Tokyo, Japan) was added to a vigorously-stirred mixture of N-(3-dimethylaminopropyl)-N′-ethylcarbodiimide hydrochloride (EDC. HCl) (288 mg, 1.5 mmol, purchased from TCI, Tokyo, Japan), 1-hydroxybenzotriazole (HOBt) (202 mg, 1.5 mmol, purchased from Alfa Aesar, Singapore) and triethylamine (0.35 mL, 2.5 mmol) in anhydrous dichloromethane (4.0 mL). After stirring for 10 minutes at ambient temperature, 1-aza-18-crown [6] (263 mg, 1.0 mmol, purchased from Sigma-Aldrich, Singapore) was added portionwise as a solution in dichloromethane (1.0 mL). After stirring overnight for 16 hours at ambient temperature, the reaction mixture was diluted to 20 mL, then washed with water (2×20 mL), and the combined aqueous phase was back-extracted with dichloromethane (20 mL). The combined organics were dried with anhydrous magnesium sulfate, filtered and solvent removed in vacuo. Purification by silica gel column chromatography (eluent: 4% MeOH/CH₂Cl₂ v/v) afforded the product as a highly-viscous colourless liquid (276 mg, 77%). ¹H NMR (CDCl₃, 500 MHZ): 5.79 (1H, m, H_{b}), 4.99 (2H, m, Hₐ), 3.61-3.66 (24H, m, H_{f-k}), 2.40 (2H, t, ³J=7.5 Hz, Hₑ), 2.09 (2H, quart., ³J=7.5 Hz, H_{c}), 1.75 (2H, quint., ³J=7.5 Hz, Hₐ).

### Example 12—Preparation of Single-Component Potassium Selective Membrane

A cocktail of the single-component potassium selective membrane was prepared by mixing 2.5 weight % of potassium ionophore 12 and 10-70 mol % of anionic lipophilic salt 2-acrylamido-2-methyl-1-propanesulfonic acid 13 with 2,2-dimethoxy-2-phenylacetophenone (DMPP, 1.2 weight %) and 1,6-hexanediol diacrylate (HDDA, 0.1 weight %) in n-butyl acrylate (nBA) with up to 20 weight % methyl methacrylate (MMA) or tetrahydrofurfuryl acrylate (THFA). A small amount of co-solvent, methanol (MeOH) or N, N-dimethylacetamide (DMAc) was added to dissolve all the precursors. Key compositions of the potassium selective membranes tested are described in Table 8.

TABLE 8
Key Compositions of Single-component Potassium Selective Membranes Tested

| | Ionophore | Sulfonic | | | Co- |
|---|---|---|---|---|---|
| | 12 | acid 13 | Co-solvent/ | nBA | monomer/ |
| | (weight %) | (weight %) | [13] (g L⁻¹) | (weight %) | weight % |
| Membrane 1 | 2.5 | 0.15 | MeOH/33 | 86.5 | MMA/9.6 |
| Membrane 2 | 2.5 | 0.43 | MeOH/33 | 86.1 | MMA/9.6 |
| Membrane 3 | 2.5 | 0.72 | MeOH/33 | 85.9 | MMA/9.5 |
| Membrane 4 | 2.5 | 0.72 | DMAc/122 | 85.9 | MMA/9.5 |
| Membrane 5 | 2.5 | 1.01 | DMAc/122 | 85.7 | MMA/9.5 |
| Membrane 6 | 2.5 | 0.72 | DMAc/122 | 85.9 | THFA/9.5 |
| Membrane 7 | 2.5 | 1.01 | DMAc/122 | 76.2 | MMA/19.0 |

A representative example of the preparation of Membrane 5 electrode is shown as follows:

To 3.1 mg of DMPP in a glass vial that was protected from light was added 144 μL of nBA and 2.6 μL of HDDA. The base membrane mixture was stirred at room temperature until all solids dissolved.

20 mg of sulfonic acid 13 was dissolved in 164 μL of DMAc in a separate vial. The lipophilic salt solution was stirred at room temperature until all solids dissolved.

To 2.5 mg of ionophore 12 was added 56.9 μL of base membrane mixture, 39.8 μL of nBA, 10.1 μL of MMA and 8.3 μL of lipophilic salt 13 in DMAc solution. The single-component potassium selective membrane cocktail was stirred at room temperature and used on the same day.

As a comparison, a conventional two-component, plasticiser free potassium selective membrane with mobile lipophilic salt KTCIPB was prepared as follows:

7.0 mg of KTCIPB (purchased from Alfa Aesar, Singapore) was dissolved in 60 μL of nBA in a separate vial. The lipophilic salt solution was stirred at room temperature until all solids dissolved.

To 2 mg of ionophore 12 was added 56.9 μL of base membrane mixture, 39.8 μL of nBA, and 13.4 μL of the KTCIPB in nBA solution. The two-component potassium selective membrane cocktail was stirred at room temperature and used on the same day.

All membrane cocktails were cast onto polyaniline-coated screen-printed carbon electrode (4 mm diameter, Dropsens) as follows:

In a nitrogen-filled glovebox, 3 μL of the single-component potassium selective membrane cocktail was cast onto the electrode. The mixture was photocured in under a UVA array (UVAHAND 250, Hönle UV technology) at a distance of 50 mm for 15 minutes. After membrane casting, the protons from anionic lipophilic salt 13 were exchanged for potassium ions by soaking in 0.1 M potassium nitrate solution for at least 24 hours.

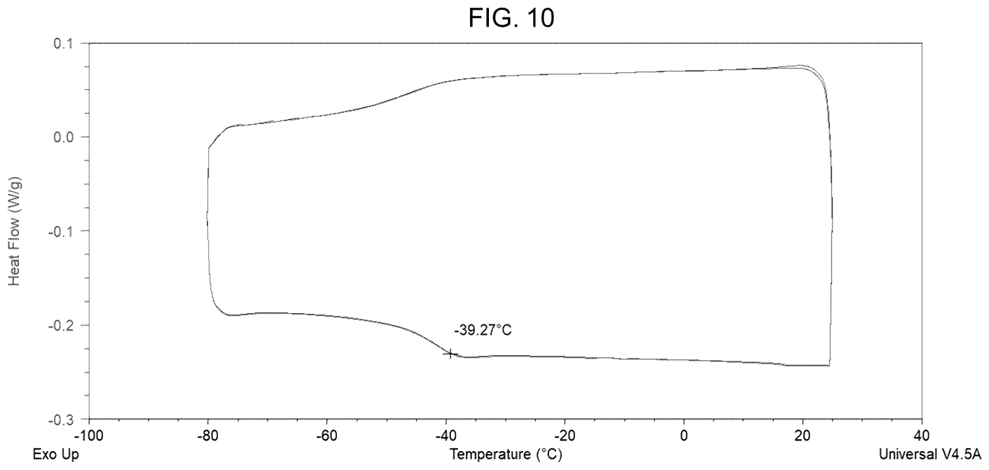

Glass transition temperature of the membranes were obtained via differential scanning calorimetry (DSC) using TA instruments DSC Q100. Membranes were deposited and cured or dried onto aluminum trays directly and sealed hermetically. The hermetically sealed pans were then cycled between 25° C. and −80° C. at a rate of 5° C./minute and the onset of the observed glass transition in the heating cycle was recorded as the glass transition temperature of the membrane. Polymers with glass transition temperature of less than −20° C. were self-plasticising. A representative DSC plot of the single-component potassium selective membrane (membrane 5) is shown in FIG. 10. The glass transition temperatures of the membrane of the present disclosure was found to be −39.3° C. which indicated that the membrane was self-plasticising. In addition, only a single glass transition was observed for the membrane suggesting that there was no phase separation within the membrane and the membrane as of a single component.

### Example 13—Performance of All-Solid-State Potassium Selective Electrode

The potassium selective membranes that were casted and cured onto an electrode as described in Example 12 formed all-solid-state nitrate selective electrodes.

Prior to testing, the all-solid-state potassium selective electrodes were conditioned in 1 mM potassium nitrate solution (prepared from solid potassium nitrate salt purchased from VWR, Singapore) for at least 16 hours. The conditioned electrodes were tested for their limit of detection, sensitivity to potassium ion and selectivity against sodium and ammonium ions.

A potentiostat (mStat8000 Multi Potentiostat/Galvanostat, DRP-STAT8000) or a pH meter was used to measure the open circuit potential between the ion selective electrode and a reference electrode. The reference electrode used for the experiments was a double junction silver/silver chloride (Ag/AgCl) reference with 3 M potassium chloride as inner electrolyte and 1 M lithium acetate as outer electrolyte. Both the ion selective electrode and reference electrode were placed in the same solution; different concentrations of solutions containing potassium nitrate, sodium nitrate and ammonium nitrate were tested.

The sensitivity and limit of detection of the electrode were evaluated by measuring the open circuit potential between the two electrodes in potassium nitrate solutions with concentration ranging from 0.0001 mM to 0.1 M. The sensitivity corresponded to the change in potential per decade change in concentration and the limit of detection corresponded to the lowest concentration at which there was observable change in potential, which was defined as the point of the intersection between a linear extrapolation of the Nernstian slope, and the horizontal part of the upper curve where the EMF was a constant value.

Based on IUPAC recommendations, the selectivity of the electrode against sodium and ammonium anions was evaluated using the fixed interference method (FIM). The open circuit potential was measured when the electrodes were placed in solutions in which concentration of the interfering ion was fixed while the concentration of potassium ions were varied from 0.001 mM to 100 mM. For ammonium ions the concentration was fixed at 0.1 mM, while for sodium ions the concentration was fixed at 10 mM.

A summary of the effect of membrane composition on the performance of the single-component potassium selective membrane is as follows:
Membranes with DMAc as co-solvent had more reproducible sensitivity performances than membranes with MeOH as co-solvent (Membranes 1 to 3 vs. 5 to 7)
Membranes with more lipophilic salt (up to 70 mol %) showed better selectivity for potassium ion against ammonium ion (Membranes 4 vs. 5)
Membranes with 9.5 wt % MMA co-monomer have lower noise than membranes with 9.5 wt % THFA or 19.0 wt % MMA (Membranes 5 vs. 6 and 7)

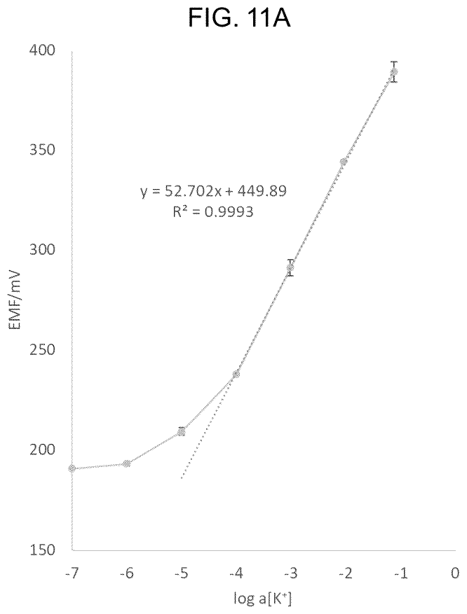

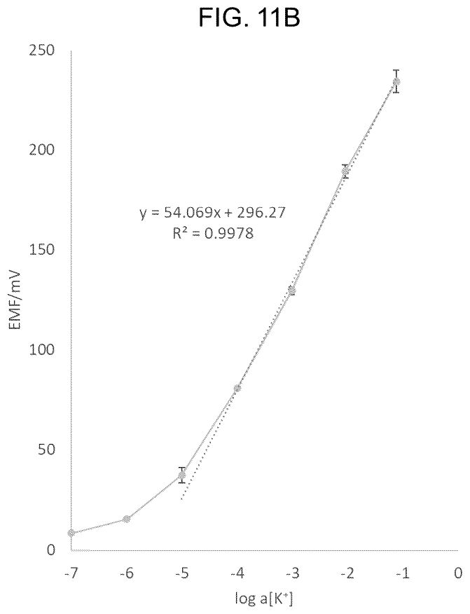

A representative plot of the potassium sensitivity performance of the single-component electrode of the present disclosure (Membrane 5) in comparison to the two-component electrode is shown in FIGS. 11A and 11B. For the single-component electrode, sensitivity to potassium was 52.7 mV/decade, which was close to the theoretical maximum of 59 mV/decade governed by Nernst law. The electrodes of the present disclosure showed response within 30 seconds of a change in potassium concentration, and the limit of detection was 0.012 mM. These values were comparable to the two-component electrode (see Table 9).

A comparison of the key characteristics of the single-component potassium selective electrode of the present disclosure and the conventional two-component potassium selective electrode is shown in Table 9. In comparison to the two-component electrode, the single-component electrode had similar selectivity for potassium against sodium (Na⁺) and better selectivity for potassium against ammonium (NH₄⁺).

TABLE 9
Key Characteristics of Two-component and Single-component
(Membrane 5) Potassium Selective Electrodes

| Characteristic | Single-component | Two-component |
|---|---|---|
| Sensitivity Slope/ | 52.7 | 54.1 |
| mV decade⁻¹ | | |
| Detection Limit/ | −4.9 | −5.3 |
| log a[K⁺] | (0.012 mM) | (0.005 mM) |
| Selectivity vs. Na⁺/ | −2.3 | −2.3 |
| log K[K, Na] | (200 × selective | (200 × selective |
| | for K⁺) | for K⁺) |
| Selectivity vs. NH₄⁺/ | −0.5 | −0.35 |
| log K[K, NH₄] | (3.2 × selective | (2.2 × selective |
| | for K⁺) | for K⁺) |

To determine the lifespan of the electrodes, accelerated testing was performed by soaking the all-solid-state electrodes in 1 mM potassium nitrate solution at 80° C. while measuring the electrode performance after every 24-72 hours; testing was performed at room temperature. The accelerated test speeded up the degradation process by about 45 times, i.e., electrodes which performed well after 1 day under accelerated conditions were expected to retain their performance for 1.5 months at 25° C. Therefore, an accelerated lifespan testing for 8 days at 80° C. was almost equivalent to about 360 days at 25° C.

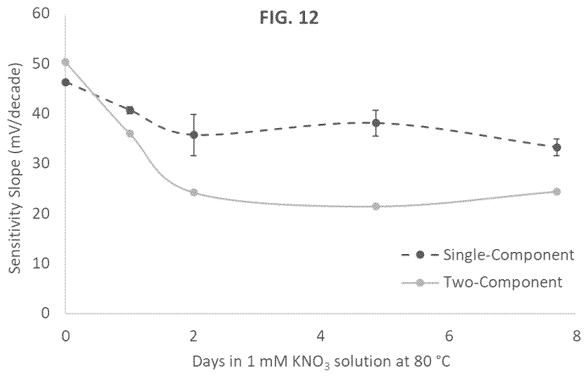

A representative plot of the accelerated testing performance of our single-component electrode (Membrane 5) in comparison to the two-component electrode is shown in FIG. 12. The two-component electrode rapidly lost potassium sensitivity after 24 hours and had lost >50% sensitivity within 48 hours, corresponding to about 45 and 90 days at 25° C.

In contrast, the single-component electrode of the present disclosure only lost <20% of sensitivity towards potassium after 48 hours and remained stable throughout the remainder of the testing duration. This represented continuous usage of the single-component electrode for almost 1 year. It should be noted however, that these results represent a ‘worst-case scenario’, and smaller losses of electrode's potassium selectivity were expected when deployed under actual field settings. It was very likely that the excessively harsh conditions of the accelerated lifespan tests (80° C.) could cause damage to the membranes that would not be expected under ambient conditions in the field, where temperatures were not expected to exceed 45° C.

### INDUSTRIAL APPLICABILITY

The membranes and electrodes of the disclosure may be used in a variety of applications such as ion sensors, wearable sensors, water quality sensors, agriculture sensors, environmental sensors, process monitoring sensors, membranes for ion concentration or separation, energy storage devices, biosensors, implantable electrodes or an electrode in capacitors or organic microelectronics.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. An ion selective membrane comprising a polymer matrix and an ionic lipophilic additive covalently bonded to the polymer matrix.

2. The ion selective membrane of claim 1, wherein the ionic lipophilic additive comprises an optionally substituted C₁ to C₂₀ alkylene group.

3. The ion selective membrane of claim 2, wherein the C₁ to C₂₀ alkylene group comprises a substituent having at least one lipophilic group and at least one charged group that are covalently bonded together.

4. The ion selective membrane of claim 1, further comprising an ionophore covalently bonded to the polymer matrix.

5. The ion selective membrane of claim 4, wherein the ionophore has a formula selected from 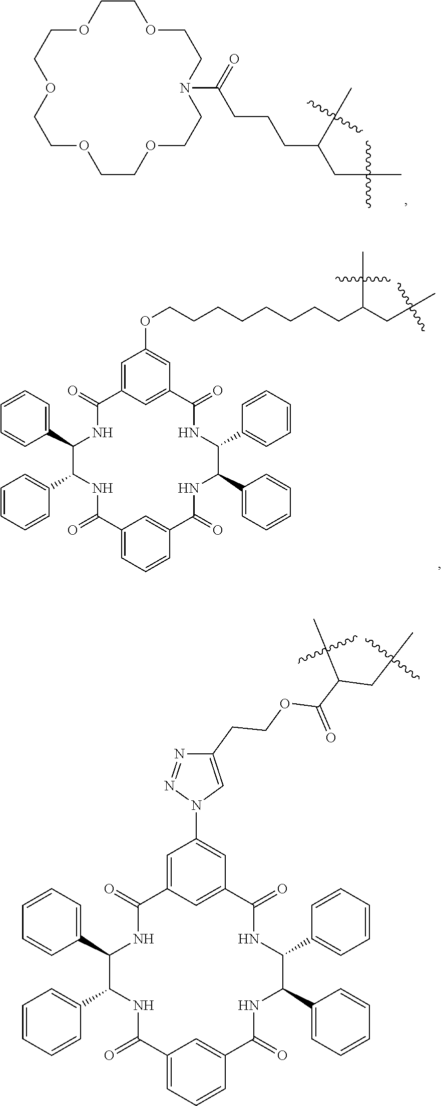 [SMILES: *CC(*)CCCC(=O)N1CCOCCOCCOCCOCCOCC1 ; *CC(*)CCCCCCCCOc1cc2cc(c1)C(=O)N[C@H](c1ccccc1)[C@@H](c1ccccc1)NC(=O)c1cccc(c1)C(=O)N[C@H](c1ccccc1)[C@@H](c1ccccc1)NC2=O ; *CC(*)C(=O)OCCc1cn(-c2cc3cc(c2)C(=O)N[C@H](c2ccccc2)[C@@H](c2ccccc2)NC(=O)c2cccc(c2)C(=O)N[C@H](c2ccccc2)[C@@H](c2ccccc2)NC3=O)nn1]
or combinations thereof.

6. The ion selective membrane of claim 4, wherein the ionophore does not comprise metal.

7. The ion selective membrane of claim 1, which consists of the polymer matrix and the ionic lipophilic additive.

8. A method of preparing an ion selective membrane, comprising the steps of:
(a) mixing an ionic lipophilic additive monomer and a membrane base to form a mixture; and
(b) casting and curing the mixture of step (a) to form the membrane.

9. The method of claim 8, further comprising a step of adding an ionophore monomer into the mixture of step (a) after step (a) but before step (b).

10. The method of claim 9, wherein the ionophore monomer is selected from the compounds of formula

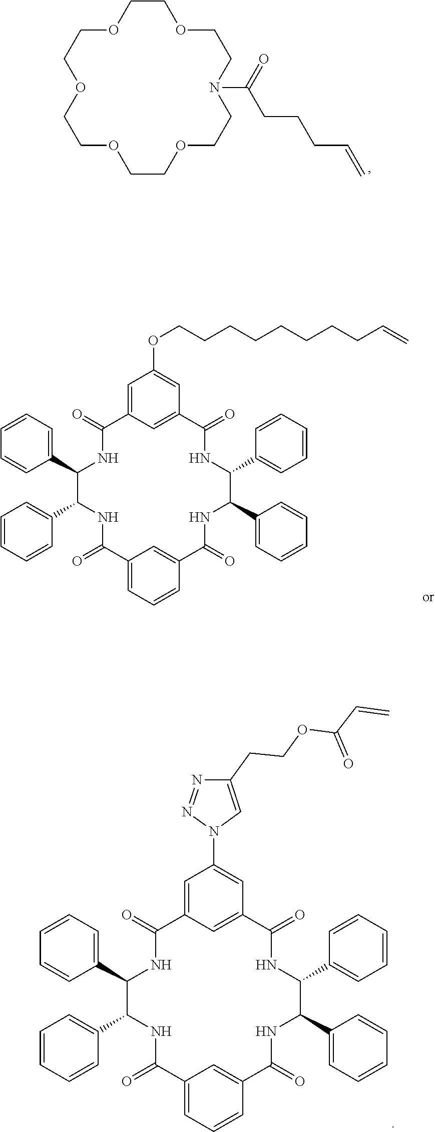 [SMILES: C=CCCCC(=O)N1CCOCCOCCOCCOCCOCC1 ; C=CCCCCCCCCOc1cc2cc(c1)C(=O)N[C@H](c1ccccc1)[C@@H](c1ccccc1)NC(=O)c1cccc(c1)C(=O)N[C@H](c1ccccc1)[C@@H](c1ccccc1)NC2=O ; C=CC(=O)OCCc1cn(-c2cc3cc(c2)C(=O)N[C@H](c2ccccc2)[C@@H](c2ccccc2)NC(=O)c2cccc(c2)C(=O)N[C@H](c2ccccc2)[C@@H](c2ccccc2)NC3=O)nn1]

11. The method of claim 9, wherein the ionophore monomer is added at a weight percentage in the range of 0.5 weight % to 15 weight %, based on the total weight of the mixture of step (a).

12. The method of claim 8, wherein the ionic lipophilic additive monomer is added at a weight percentage in the range of 0.5 weight % to 20 weight %, based on the total weight of the mixture of step (a).

13. The method of claim 8, further comprising a step of adding a co-solvent into the mixture of step (a) after step (a) but before step (b).

14. The method of claim 8, wherein the casting and curing step (b) comprises casting the mixture of step (a) on a substrate and subsequently curing the mixture by irradiation from a light source.

15. The method of claim 8, wherein the casting and curing step (b) comprises casting the mixture of step (a) on an electrode.

16. The method of claim 8, wherein the casting and curing step (b) comprises curing the mixture of step (a) by irradiation from a light source that emits light at a power in the range of 20 mW/cm² to 250 mW/cm².

17. An ion selective electrode comprising the ion selective membrane of claim 1 and an electrode.

18. The ion selective electrode of claim 17, which is an all-solid-state ion selective electrode.

19. A method of preparing an ion selective electrode, comprising the steps of:
(a) providing a mixture of an ionic lipophilic additive monomer and a membrane base; and
(b) casting and curing the mixture of step (a) on an electrode to form the ion selective electrode.

20. The method of claim 19, further comprising a step (c) of conditioning the ion selective electrode after step (b).
